(19) United States
(12) Patent Application Publication
(10) Pub. No.: US 2012/0086806 A1
(43) Pub. Date: Apr. 12, 2012

(54) ELECTRONIC DEVICE AND SECURITY METHOD OF ELECTRONIC DEVICE

(76) Inventors: Kenji HIRAMINE, Kawasaki (JP); Masashi Hattori, Kawasaki (JP)

(21) Appl. No.: 13/328,510

(22) Filed: Dec. 16, 2011

Related U.S. Application Data
(63) Continuation of application No. PCT/JP2009/062616, filed on Jul. 10, 2009.

(51) Int. Cl. H04N 7/18

(52) U.S. Cl. 348/143; 348/E07.085

(57) ABSTRACT

An electronic device includes an operating unit, a behavioral information acquiring unit to acquire behavioral information of an operator as triggered by operation of the operating unit, a matching unit to match input matching information input by the operator against registered matching information, a recording unit to be recorded with the behavioral information, and a recording control unit to record, when the matching unit determines that the input matching information is not coincident with the registered matching information, the behavioral information in the recording unit.

### CROSS-REFERENCE TO RELATED APPLICATIONS

This is a continuation of Application PCT/JP2009/062616, filed on Jul. 10, 2009, now pending, the entire contents of which are incorporated herein by reference.

### FIELD

The embodiments discussed herein are related to a security function of an electronic device such as a personal computer etc. and related to, e.g., the electronic device including an operation monitoring function, a security method of the electronic device, a security program thereof and a recording medium.

### BACKGROUND

The electronic device such as a personal computer and a mobile phone is exposed to a risk of an unauthorized access from people other than a possessor.

Therefore, a security measure such as identity authentication based on matching (verification) with a password number etc. and specifying an unauthorized accessing person, is conducted for preventing the unauthorized access.

In regard to this type of security, a known mobile terminal device equipped with a camera is a device having a function of capturing an image of an operator when an input count of how many times the operator inputs passwords reaches a predetermined count (Patent document 1).

[Patent document 1] Japanese Laid-Open Patent Publication No. 2008-167075

### SUMMARY

According to an aspect of the embodiment, an electronic device includes an operating unit, a behavioral information acquiring unit to acquire behavioral information of an operator as triggered by operation of the operating unit, a matching unit to match input matching information input by the operator against registered matching information, a recording unit to be recorded with the behavioral information, and a recording control unit to record, when the matching unit determines that the input matching information is not coincident with the registered matching information, the behavioral information in the recording unit.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating an example of a configuration of an electronic device according to a first embodiment.

FIG. 2 is a view depicting a status of acquiring behavioral information related to the electronic device.

FIG. 3 is a flowchart illustrating a processing procedure to acquire the behavioral information.

FIG. 4 is a diagram illustrating an example of a configuration of the electronic device according to a second embodiment.

FIG. 5 is a view depicting a display example in the case of locking a screen.

FIG. 6 is a view illustrating a display example of an alarm message if an unauthorized access is recorded.

FIG. 7 is a flowchart illustrating a processing procedure to acquire the behavioral information according to the second embodiment.

FIG. 8 is a diagram illustrating an example of a configuration of the electronic device according to a third embodiment.

FIG. 9 is a view depicting a display example of the alarm message due to an excess over set time.

FIG. 10 is a flowchart illustrating an example of a processing procedure to acquire the behavioral information according to a third embodiment.

FIG. 11 is a diagram illustrating an example of a configuration of the electronic device according to a fourth embodiment.

FIG. 12 is a flowchart illustrating a processing procedure including an operation detecting process.

FIG. 13 is a diagram illustrating an example of a configuration of the electronic device according to a fifth embodiment.

FIG. 14 is a flowchart illustrating an example of a processing procedure to acquire the behavioral information according to the fifth embodiment.

FIG. 15 is a flowchart illustrating an example of a processing procedure of the electronic device according to the fifth embodiment.

FIG. 16 is a diagram illustrating an example of a configuration of the electronic device according to a sixth embodiment.

FIG. 17 is a view illustrating a display example of the behavioral information received by another electronic device.

FIG. 18 is a view illustrating a display example of position information of the electronic device that is received by another electronic device.

FIG. 19 is a flowchart illustrating an example of a communication process of the electronic device.

FIG. 20 is a flowchart illustrating an example of a processing procedure of the electronic device according to the sixth embodiment.

FIG. 21 is a flowchart illustrating an example of a pre-setting process of the electronic device.

FIG. 22 is a diagram illustrating an example of a setting screen of the electronic device.

FIG. 23 is a view depicting an example of an external configuration of a PC.

FIG. 24 is a view illustrating an example of a behavioral information acquisition area about the PC.

FIG. 25 is a diagram illustrating an example a hardware architecture of the PC.

FIG. 26 is a diagram illustrating an example of a configuration of a memory.

FIG. 27 is a view depicting an example of a configuration of a mobile phone according to another embodiment.

FIG. 28 is a view depicting an example of a configuration of a PDA according to another embodiment.

### DESCRIPTION OF EMBODIMENTS

By the way, the image is to be captured even by use of a camera function when triggered by inputting the passwords plural number of times, in which case the image is not captured if an unauthorized accessing person stops accessing before reaching a set count.

If an uniform restriction is provided in monitoring the unauthorized person, there is a possibility that the information might be stolen by the unauthorized accessing person within this restriction.

Further, when the information is stolen, inconvenience is that the unauthorized access and the unauthorized accessing person are unable to be known.

### First Embodiment

A first embodiment is that an operation of an operation unit triggers acquisition of behavioral information of an operator and records, if the operator turns out to be an unauthorized accessing person on the basis of a matching process with the operator, the acquired behavioral information.

This scheme enables the unauthorized access to be known and the unauthorized accessing person to be specified.

Herein, the behavioral information is sufficient if containing anyone or two or more categories or all of these categories of information such as image capture information, voice recording information or biometric information.

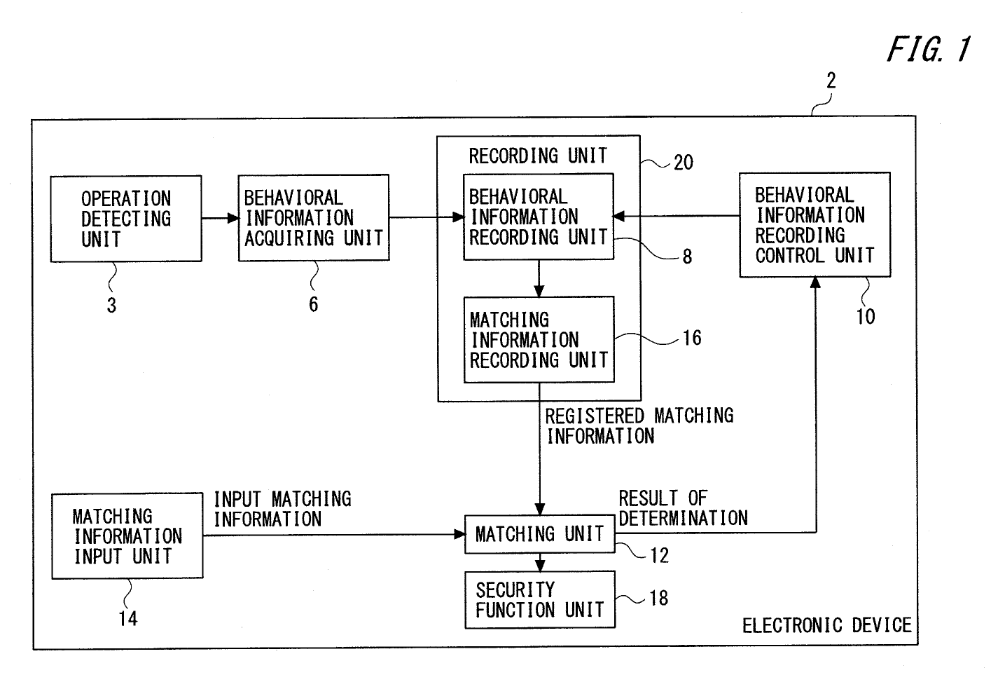

A reference to FIG. 1 will be made with respect to the first embodiment. FIG. 1 is a diagram illustrating an example of a configuration of an electronic device according to the first embodiment.

It should be noted that the configuration depicted in FIG. 1 is one example, and the present embodiment is not limited to this configuration.

This electronic device 2 is one example of the electronic device of the present disclosure or one example of applying a security method thereof or incorporating a security program or a recording medium thereof. The electronic device 2 includes the monitoring function described above and the recording function of the unauthorized access by a person who does not hold a regular operation authority, a function of specifying an unauthorized accessing person, and so on. Then, the electronic device 2 is exemplified such as a personal computer (PC), a mobile phone and a PDA (Personal Digital Assistant) device.

In the electronic device 2, as the security function, the acquisition of the behavioral information of this operator is triggered by operating the electronic device, and the behavioral information is recorded under a given condition.

This being the case, the electronic device 2 includes, as illustrated in FIG. 1, an operation detecting unit 3, a behavioral information acquiring unit 6, a behavioral information recording unit 8, a behavioral information recording control unit 10, a matching unit 12, a matching information input unit 14, a matching information recording unit 16 and a security function unit 18.

The operation detecting unit 3 is an example of a unit which detects the operation of an operating unit installed on the electronic device 2. The operating unit is a unit such as a start-up switch which starts up the electronic device 2 and a keyboard, and a depressing operation thereof is detected by the operation detecting unit 3. Then, for example, a timing of starting to acquire behavioral information is triggered by detecting this operation.

The behavioral information acquiring unit 6 is one example of a behavioral information acquiring unit which acquires the behavioral information of the operator of the electronic device 2, and has a configuration including, e.g., a camera for acquiring the image capture information, a microphone and a recorder which acquire the voice recording information, a biometric information sensor which acquires the biometric information such as fingerprint information and face contour information, etc. The behavioral information is, as already described, acquired continuously, intermittently or discontinuously, in addition to when detecting that the start-up switch is depressed, e.g., when inputting and matching (verifying) a password that will be described later on and when outputting determination of a result of the matching thereof.

The behavioral information recording unit 8 is one example of a recording unit of the behavioral information acquired by the electronic device 2, built up in the recording unit 20 and records the image capture information, the voice recording information, etc. that are acquired by the behavioral information acquiring unit 6. This behavioral information recording unit 8 may involve utilizing, e.g., a nonvolatile memory etc.

The behavioral information recording control unit 10 is one example of a recording control unit which controls a recording process of the acquired behavioral information with respect to the behavioral information recording unit 8, and controls as to whether the behavioral information is recorded by the behavioral information recording unit 8 in accordance with a result of the matching with the operator. For example, in the matching process of the electronic device 2, the operator performing the start-up operation etc. is determined to be a person not holding the operation authority, in which case the acquired behavioral information is attached with identifying information and thus recorded. The attachment of this identifying information is one example of a process of enabling the information to be specified as the behavioral information of the unauthorized accessing person, and includes attaching, e.g., date/time information and other identifiable items of information. Further, a process enabling the behavioral information to be specified may involve, for example, executing a process such as transferring the behavioral information to a specified folder and a specified memory address of the behavioral information recording unit 8.

The matching unit 12 is one example of a matching unit which matches input matching information input by the operator against registered matching information stored in a matching information recording unit 16, thus matching (checking) as to whether the operator of the electronic device 2 is the authorized person. Then, as a result of the matching, when determining that the operator is the person holding the authority to operate the electronic device 2, and the result of this determination is output, which leads to a log-in status (Log in) to the electronic device 2. The result of this determination is output to, e.g., the behavioral information recording control unit 10, the security function unit 18, etc., which have previously been described. In this matching process, for instance, identity verification making use of the biometric information or a magnetic card etc. recorded with the individual information etc. may also be conducted in addition to the password matching (password verification) using numerals, characters, etc.

Note that the matching unit used in this matching unit 12 is not limited to the single authentication and the matching unit may perform, e.g., a combination of magnetic card authentication, password authentication, etc. Then, the behavioral information may be acquired each time the matching information is input.

The matching information input unit 14 is one example of a unit which acquires the matching information from the operator of the electronic device 2 and, as previously mentioned, takes in the numerals, the characters, etc. via, e.g., the keyboard etc. in the case of the password matching. Further, the biometric authentication, for instance, involves taking in, e.g., fingerprint information, vein information, etc. Alternatively, ID card information etc. is read by use of a card reader. Then, the taken-in items of matching information are transmitted to the matching unit 12.

The matching information recording unit 16 is one example of a recording unit of the registered matching information used for the identity verification or the matching process about whether to hold the authority for the use, and retains, as previously stated, the password information, the biometric information defined as the identity information, etc.

The security function unit 18 is one example of a function inhibiting unit which inhibits, upon receiving the result of the determination from the matching unit 12, a part of the functions or the whole functions of the electronic device 2. The security function unit 18, for example, when receiving the result of the determination saying that the input matching information is not coincident with the registered matching information, requests the operator to input the data for matching once again. Further, if not determined to be the regular user even by performing the matching process more than once, the acquired behavioral information is recorded on the behavioral information recording unit 8, and, along with this recording, a screen of the electronic device 2 is locked. Moreover, in the case of receiving the result of the determination saying that the authority for the use is held or the identity is authenticated, the lock function is canceled, thereby starting booting the electronic device 2.

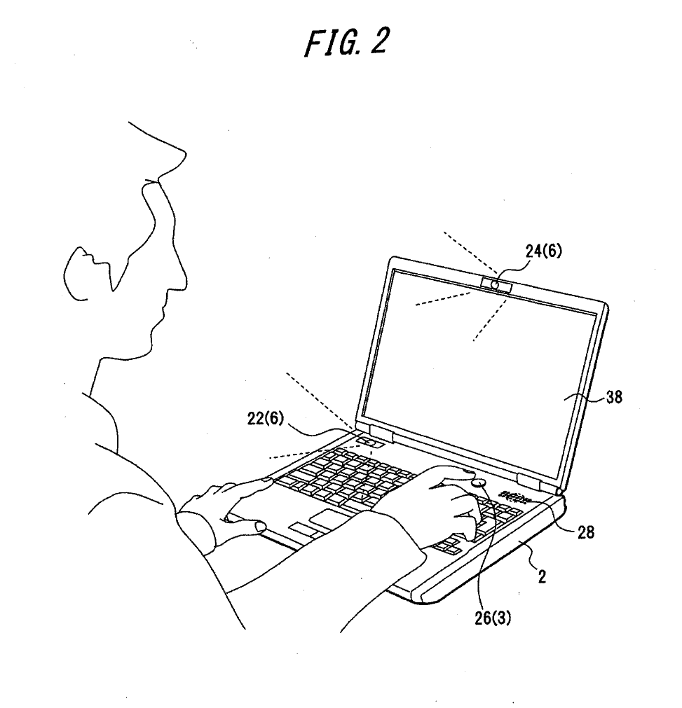

Next, a reference to FIG. 2 will be made for recording the behavioral information by the electronic device. FIG. 2 is a view depicting a status of how the behavioral information is acquired by the electronic device. It is to be noted that a configuration illustrated in FIG. 2 is one example, but the embodiment is not limited to this example.

The behavioral information acquired by the electronic device 2 is categorized into the image capture information given by a security camera 22 and an inbuilt camera 24 and into the voice recording information of voices (sounds) collected and recorded by a microphone (Microphone) 28 with respect to the operator of the electronic device 2. The behavioral information is acquired upon being triggered by depressing, e.g., a start-up switch 26 etc. defined as the operating unit continuously, intermittently or discontinuously.

In the acquisition of this behavioral information, a behavior area of the operator who touches, e.g., the start-up switch etc. is set as a behavioral information acquisition area. What is set as this behavioral information acquisition area is, e.g., a range enabled to capture an image of an appearance and an action of the person who operates the electronic device 2 or enabled to collect the voices etc. of this person. The acquisition of the behavioral information of the images captured by use of the cameras 22, 24 may involve setting the behavioral information acquisition area in a direction enabled to capture the images of a face, clothing, etc. of the operator directed toward a display screen 38 when performing, e.g., the start-up operation of the electronic device 2.

Note that installation positions of the security camera 22, the inbuilt camera 24 or the microphone 28 illustrated in FIG. 2 are one example, but the security camera 22, the inbuilt camera 24 or the microphone 28 may also be installed in any positions of the electronic device 2.

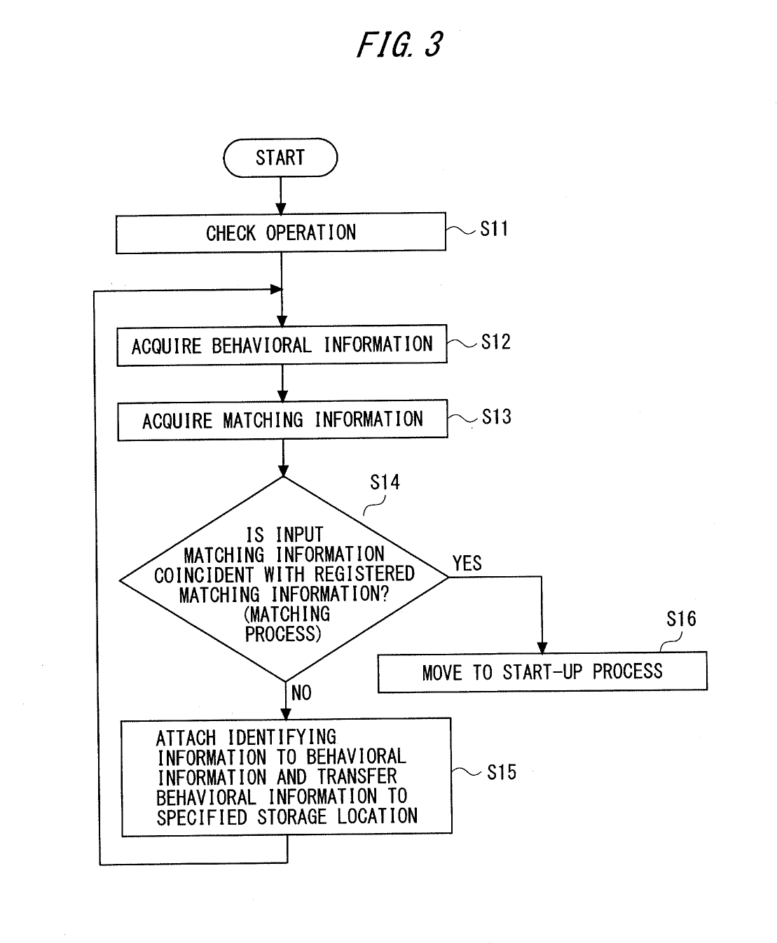

Next, a reference to FIG. 3 will be made for a process of recording the behavioral information by this electronic device. FIG. 3 is a flowchart illustrating an example of a behavioral information acquisition processing procedure. Note that a processing content and the processing procedure depicted in FIG. 3 are given by way of one example, but the embodiment is not limited to this example.

This behavioral information recording process is one example of a security method or a security program of the electronic device, and, for instance, the acquisition of the behavioral information is triggered by operating the electronic device. Further, the matching process is executed in away that acquires the matching information, and such a specifying process is executed corresponding to a result of the determination in the matching process that the acquired behavioral information is specified as the information of the unauthorized accessing person.

Then, as depicted in FIG. 3, an operation check of the electronic device 2 is done (step S11). This operation check involves detecting the operation of, e.g., the start-up switch 26 etc. by the operation detecting unit 3.

A start of the acquisition of the behavioral information of the operator of the electronic device 2 is triggered by detecting this operation (step S12). In the acquisition of the behavioral information, the behavioral information may be recorded by operating all of the functions without being limited to the case of conducting only one of capturing the static images and the dynamic images by the cameras 22, 24 and recording the voices and the ambient sounds by the microphone 28. Further, when recording the behavioral information, a piece of recoding date/time information of this record etc. is also recorded together.

Moreover, along with acquiring the behavioral information, the matching information for executing the matching process with the operator is acquired (step S13). As the matching information, the input matching information of the operator of the electronic device 2, e.g., the password, the biometric information, etc., acquired by the above-mentioned matching information input unit 14 are utilized. The acquisition of this matching information may involve displaying a purport (message) of prompting the operator to input, for instance, the password etc. on the display screen of the electronic device 2.

After acquiring the matching information, for example, the registered matching information stored in the matching information recording unit 16 etc. is read and the matching process as to whether the registered matching information is coincident with the input matching information or not is done (step S14).

As a result of the matching process, when the input matching information is not coincident with the registered matching information (NO in step S14), the behavioral information recording control circuit 10 etc. is notified of this determination result. Then, the behavioral information recording control unit 10 attaches or changes the date and the time and attaches other items of identifying information to the behavioral information acquired in the start-up process of this time, transfers the behavioral information to a specified storage location (step S15) and records the behavioral information therein. Through this operation, for instance, the past behavioral information stored on the electronic device 2 is set in a status enabled to distinguish and specify the behavioral information exhibiting a high possibility of being the unauthorized accessing person who was not verified. Available areas for the specified storage location are, e.g., a specified folder within the behavioral information recording unit 8 and a specified memory address.

After attaching the identifying information etc., for example, the acquisition of the behavioral information continues (step S12), and the matching information is again acquired (step S13). Further, when the input matching information is coincident with the registered matching information, the operation moves to the start-up process of the electronic device 2 (step S16).

With such a configuration, the acquisition of the behavioral information from the operator is triggered by the operation of the operating unit, thereby improving accuracy of acquiring the unauthorized access information from the behavioral information and enhancing the monitoring function against the unauthorized access to the electronic device. Moreover, the monitoring function against the unauthorized access to the electronic device and the recording function thereof are enhanced. When there is the discrepancy between the input matching information and the registered matching information, the record of the behavioral information acquired from the operator is triggered by the operation of the operating unit, and hence it is feasible to enhance the monitor function and the recording function of the unauthorized access to the electronic device.

### Second Embodiment

A second embodiment includes a process of deleting the behavioral information acquired from persons who log in normally.

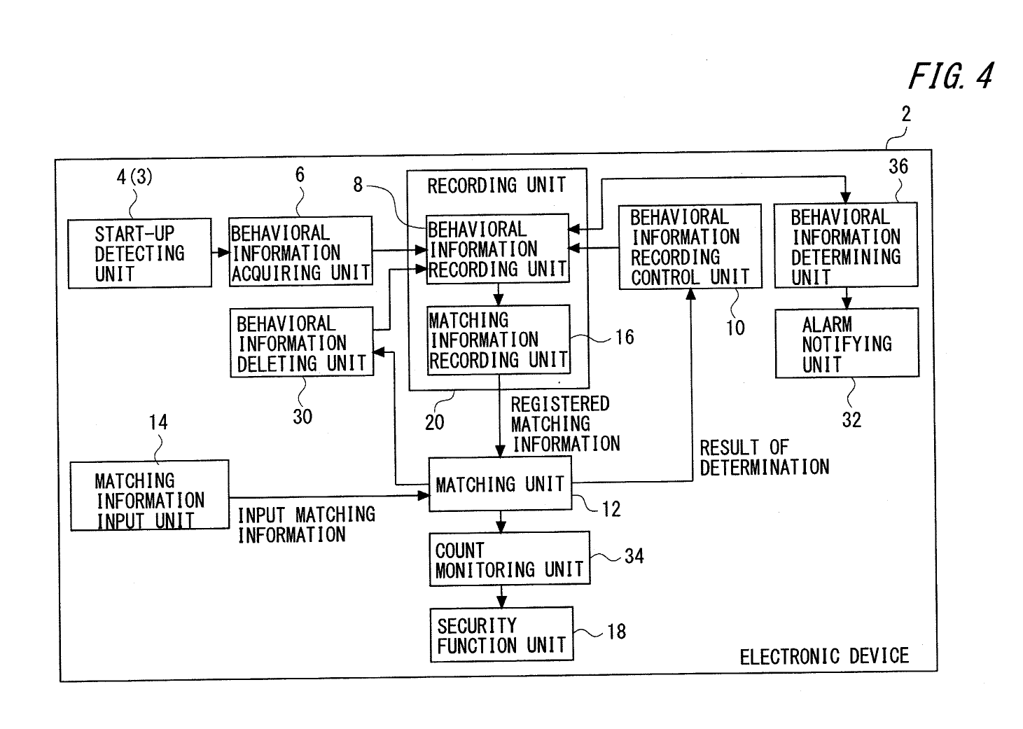

A reference to FIG. 4 will be made for the second embodiment. FIG. 4 is diagram illustrating an example of a configuration of the electronic device according to the second embodiment. The configuration illustrated in FIG. 4 is one example, and the present embodiment is not limited to such a configuration. Further, in FIG. 4, the same components as those in FIG. 1 are marked with the same numerals and symbols.

The electronic device 2 in the second embodiment includes, in addition to the configuration that has been discussed above, a configuration to display, e.g., other than deleting the immediate behavioral information of the operator who normally logs in, an alarm if there was the record of the unauthorized access anterior thereto. What is further included is a configuration for the security by locking the screen etc. when a login disable status reaches a predetermined count.

This electronic device 2 has a configuration including, in addition to the behavioral information acquiring unit 6, the behavioral information recording control unit 10, the recording unit 20, the matching unit 12 and the matching information input unit 14 that have previously been described, e.g., a start-up detecting unit 4, a behavioral information deleting unit 30, an alarm notifying unit 32, a count monitoring unit 34, a behavioral information determining unit 36, etc.

The start-up detecting unit 4 is one example of the operation detecting unit 3 described above and detects that the start-up switch 26 is depressed when starting up the electronic device 2.

The behavioral information deleting unit 30 is one example of a unit which deletes the behavioral information recorded on the behavioral information recording unit 8 etc., and executes, e.g., when succeeding in the login in the matching process, the process of deleting the behavioral information etc. acquired at that time on the basis of a predetermined condition. As a determining method of this predetermined condition, for instance, acquisition time information attached to the behavioral information and specifying information of other symbols etc. may be determined from a file name, and, in addition, the immediate behavioral information and the past behavioral information are saved in another folder and may be determined based on this folder.

The alarm notifying unit 32 is one example of a notifying unit which notifies, if the operator of the electronic device 2 is determined to be the person not holding the authority of the use, the regular operator of an alarm saying that the unauthorized access is conducted. This alarm notification involves giving, e.g., when the regular operator starts up the electronic device 2, a notification purporting that the behavioral information of the unauthorized accessing person is saved in a way that performs screen display, icon display, flickering display, voice utterance, etc. For others, e.g., the alarm display etc. against the unauthorized accessing person may also be performed when reaching a screen lock status which will be described later on.

The count monitoring unit 34 is one example of a function unit which counts and records a matching count etc. For example, the count monitoring unit 34 counts a login failure count based on matching and, when this failure count consecutively reaches a set count, notifies the security function unit 18 of this purport, thereby performing the screen lock etc.

The behavioral information determining unit 36 is one example of a function unit which determines whether the behavioral information recorded in the behavioral information recording unit 8 contains the behavioral information of the unauthorized accessing person. To be specific, it is determined whether there is the behavioral information attached with the identifying information or whether the behavioral information exists in the specified folder etc. This determination being made, if the predetermined behavioral information exists in the behavioral information recording unit 8, this implies a possibility that the electronic device 2 might be started up by the unauthorized accessing person before the start-up of this time.

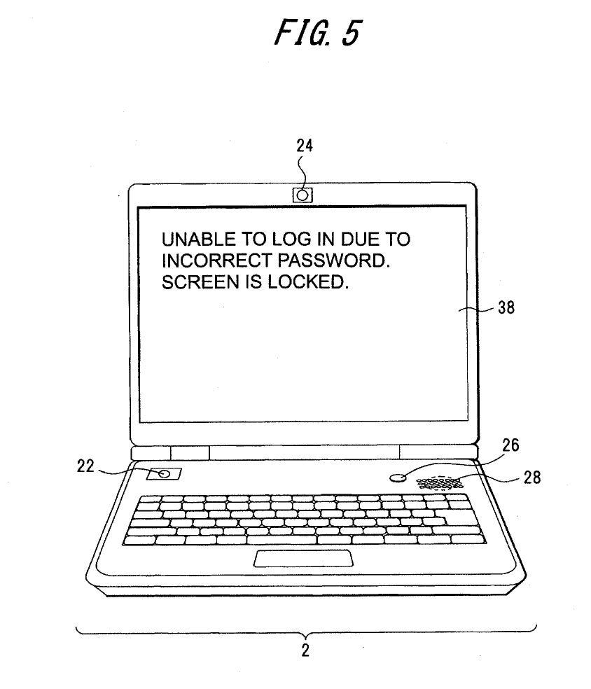

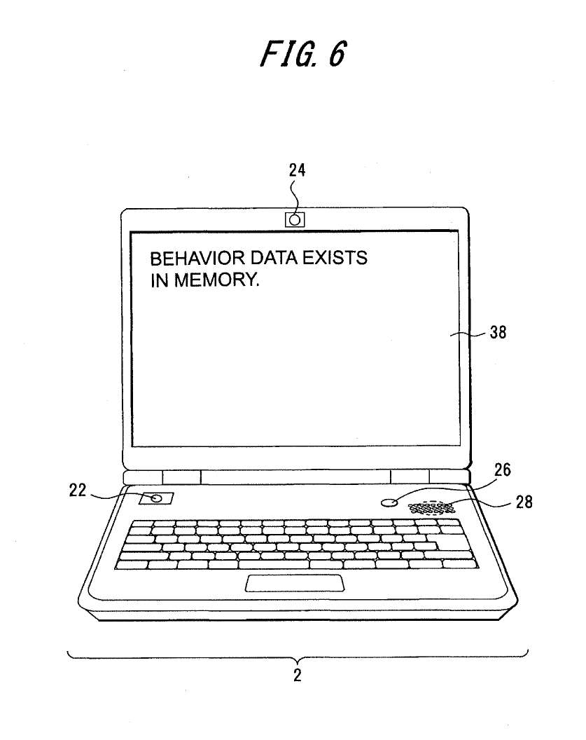

Next, a reference to FIGS. 5 and 6 will be made for the alarm notification in the electronic device. FIG. 5 is a view depicting an example of displaying the alarm when locking the screen, and FIG. 6 is a view depicting a display example of an alarm message when the unauthorized access is recorded. Note that the display contents, the display statuses and the alarm notifying unit illustrated in FIGS. 5 and 6 are given by way of one example, and the embodiment is not limited to this example.

The alarm notification in the electronic device 2 is one example of an alarming method against the unauthorized access or an alarming method of notifying the person holding the authority for the regular use that the unauthorized access was done.

As for the alarm notification against the unauthorized access, as illustrated in FIG. 5, the security function is such that, e.g., an execution count of the matching process for the login is set, and the operator repeats the failure in the matching process with the result of exceeding the set count, in which case the screen is locked. Then, the alarm message such as “Unable to log in due to the incorrect password. Screen is locked.” is displayed on the display screen 38 of the electronic device 2.

This screen lock is, as previously stated, carried out by the security function unit 18, and, for example, such a process of inhibiting functions is executed that the contents input to the electronic device 2 by operating the keyboard etc. are inhibited from being displayed on the display screen 38. Note that other security functions may involve executing processes such as locking the keyboard and the matching function or performing an account lock to lock (restrict) the authority itself for the registered information.

With this security function, at a point of time when executing the screen lock etc., the behavioral information has already been recorded a plural number of times, whereby the behavioral information enabled to specify the unauthorized accessing person can be obtained.

Further, as illustrated in FIG. 6, the alarm notification to the person holding the operation authority is that the operator, who regularly logs in, is notified of recording the behavioral information of the unauthorized accessing person to the electronic device 2. The behavioral information determining unit 36, as mentioned above, determines whether this behavioral information is recorded or not. This determination is made based on determining whether there is the identifying information attached by the behavioral information recording control unit 10 and whether the acquired behavioral information is transferred to the specified folder etc. Then, if there is the behavioral information, an alarm message such as “there is the behavior data in the memory.” is displayed on the display screen 38.

Other notifying methods based on this alarm message may involve flickering a predetermined display icon on the screen after being started up and outputting the voices. Further, when plural items of behavioral information are recorded, the already-confirmed information by the operator and not-yet-confirmed information by the operator may be displayed in a distinguishable manner.

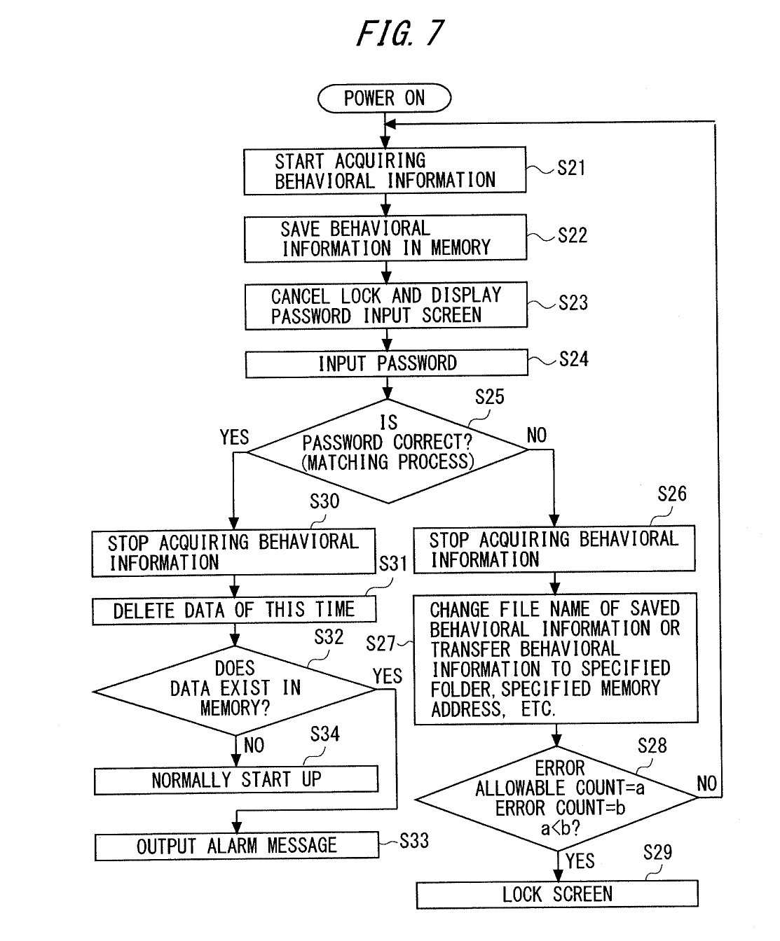

A reference to FIG. 7 will be made for a process of the security function of the electronic device. FIG. 7 is a flowchart illustrating an example of a processing procedure of the electronic device according to the second embodiment. Note that the processing contents, the processing procedure, etc. depicted in FIG. 7 are given by way of one example, and the embodiment is not limited to this example.

This process is one example of the security method or the security program of the electronic device. Then, this process involves executing the process of recording the above-mentioned behavioral information, and includes implementation of the security function based on the matching failure count, the process of deleting the behavioral information when normally logging in, the alarm process when having the behavioral information of the unauthorized accessing person, and so on.

The matching process for the login, as illustrated in FIG. 7, by way of one example, makes use of the password (Pass Word) input to the electronic device 2 by the operator.

Upon switching ON a power source of the electronic device 2, for instance, the above-mentioned start-up detecting unit 4 detects, e.g., that the start-up switch 26 such as a power button is depressed or detects a status of energization, and a start of acquiring the behavioral information is triggered by this power-on (step S21). The image capture information of the images, which are continuously or intermittently captured by, e.g., the cameras 22, 24, may be used as the behavioral information. Then, the thus-acquired behavioral information is temporarily saved in the behavioral information recording unit 8 defined as the memory (step S22). At this time, the acquired date/time information may be attached.

The matching process for the login is executed while acquiring the behavioral information. A password input screen for canceling the lock is displayed on the display screen 38 (step S23). When the operator inputs the password (step S24), it is determined whether the input password is correct (step S25). Namely, this determination entails carrying out the matching process as to whether the password defined as the input matching information is coincident with the registered matching information existing in the matching information recording unit 16 etc.

Through the matching process, if the password is incorrect (No in step S25), the acquisition of the behavioral information is stopped (step S26), the file name, as the identifying information, of the saved behavioral information is changed, or the behavioral information is transferred to and recorded in the specified folder, the specified memory address, etc. (step S27). That is to say, the access is determined to be the access of the person not holding the authority for the operation from the failure in the login in the matching process, and the behavioral information recorded based on the operation of this time is set in the specifiable status. For example, the date/time information etc. when conducting the matching is newly attached to the behavioral information, and the recording unit 20 etc. may include an individual saving location.

Then, the operation moves to the determination of an error (failure) count in the matching process. In this determination, for instance, the count monitoring unit 34 determines whether a password error count (b) exceeds an allowable count (a) (a<b) (step S28). To be specific, the access is determined to be the unauthorized access when the password error count becomes equal to or larger than the allowable count. This error count (b) may be counted by, e.g., a counter of the electronic device 2 when making the failure in the matching process (NO in step S25).

In the determination of the error count in the matching process, if the error count exceeds the allowable count (b>a) (YES in step S28), the implementation of the security function entails locking the screen as previously stated (step S29). Further, whereas if the error count does not exceed the allowable count (b<a) (NO in step S28), the operation loops back to step S21, in which the acquisition of the behavioral information is restarted and the matching process is thereby executed.

In the matching process, if the password is determined to be correct (YES in step S25), the operation moves to the start-up process of the electronic device 2 because of the operator holding the authority for the use. In the start-up process, the acquisition of the behavioral information is stopped (step S30). Then, the data of the behavioral information recorded in the matching process of this time is deleted (step S31). For example, the immediate data when logging in may be deleted as the data of this time.

Namely, this data is the behavioral information of the authorized person who holds the authority for the operation and is therefore deleted because of having no necessity for specifying the unauthorized access. A means for distinguishing between the data of this time and the data recorded otherwise applies a specific mark representing the data of this time to the file name, further creates an unauthorized person folder and a start-up folder of this time in the recording unit 20, and deletes the start-up folder of this time in accordance with a result of the password matching. Then, in the case of the failure in matching, the data in the start-up folder may be transferred to the unauthorized person folder.

After deleting the data, it is determined whether the data exists in the memory (step S32). For instance, the behavioral information determining unit 36 determines whether the behavioral information is recorded in the behavioral information recording unit 8. That is to say, as already mentioned, in step S31, the data of this time has undergone the deleting process, and hence, in this determination, if the behavioral information is recorded (YES in step S32), this implies that the unauthorized access has been conducted before starting up the electronic device 2 this time. In this case, the alarm notifying unit 32 outputs the alarm message that has already been stated (step S33). Further, if the behavioral information is not recorded (NO in step S32), the electronic device 2 is started up normally (step S34).

Note that the matching process is not, as previously stated, limited to the scheme using the password, for instance, there may be performed an authentication process using the biometric information such as the fingerprint and also using a smartcard etc. stored with ID information. Alternatively, these means may be combined. For others, the stop of the acquisition of the behavioral information is set (step S26, step S30) after the matching process (step S25), however, the setting is not limited to this mode. For example, in the case of the failure in matching (NO in step S25), the acquisition of the behavioral information may not be stopped, and further, in the case of the success in matching (YES in step S25), the acquisition of the behavioral information may continue till the start-up is done. Moreover, in the matching process, the error count exceeds the allowable count (YES in step S28), in which case this may trigger the acquisition and the record of the behavioral information.

According to such a configuration, in the same way as described above, the operation of the operating unit triggers the acquisition of the behavioral information from the operator, thereby improving the accuracy of acquiring the unauthorized access information from the behavioral information and enhancing the monitor function against the unauthorized access to the electronic device. Furthermore, there are enhanced the monitor function against and the recording function of the unauthorized access to the electronic device or the function of specifying the unauthorized accessing person. To be specific, the record of the behavioral information contributes to facilitate checking the unauthorized access and specifying the unauthorized accessing person, thereby enhancing the accuracy of checking the unauthorized access and the accuracy of specifying the unauthorized accessing person. Moreover, the record of the behavioral information acquired from the operator is triggered by operating the operating unit when the input matching information is not coincident with the registered matching information, thereby enabling the enhancement of efficiencies of the monitor function against and the recording function of the unauthorized access to the electronic device or the function of specifying the unauthorized accessing person.

Characteristic items, advantages or modified examples etc. of the first and second embodiments discussed above will be enumerated.

(1) The conventional record of the dynamic images is hard to specify the unauthorized accessing person because of a large data size. By contrast, in the embodiments discussed above, in the case of succeeding in the matching process of the password etc., the data size of the recording unit 20 can be reduced by deleting the data, thereby enabling the unauthorized access to be monitored efficiently.

(2) The behavioral information is recorded whenever started up, thereby making it possible to acquire a face image etc. of a suspicious person who gave up by seeing the locked screen.

(3) The suspicious person watches the screen when inputting the password etc. This scene is exploited for increasing a possibility that the image capture information including the face etc. can be acquired. Namely, if the normal login is done every time, a log of the picture is not left in the memory. Then, the data of the unauthorized person is left therein on the occasion of the normal login, in which case this implies, e.g., that the unauthorized person cracked the password and tried to log in while leaving an operator's seat or after returning home. Further, if the operator holding the authority erroneously inputs the password etc., though the behavioral information thereof is not deleted, if the identical person can normally log in afterward, it follows that the behavioral information data of this identical person himself or herself is to be seen, and the security function is affected very little.

(4) All pieces of behavioral information data stored in the recording unit 20 are conceived as the data of the suspicious person by deleting the behavioral information data when succeeding in matching, thereby facilitating the process of specifying the suspicious person without searching for the data.

### Third Embodiment

A third embodiment refers to determination of a period of elapse time for human verification in order to acquire the behavioral information.

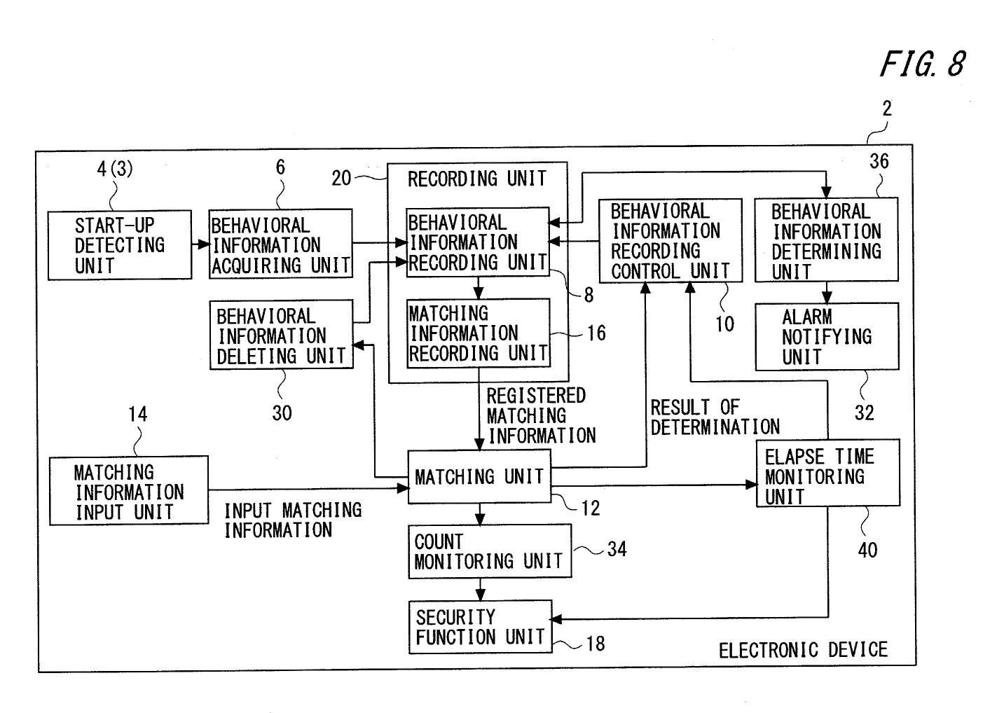

A reference to FIG. 8 will be made for the third embodiment. FIG. 8 is a diagram illustrating an example of a configuration of the electronic device according to the third embodiment. It should be noted that the configuration illustrated in FIG. 8 is one example, and the embodiment is not limited to this configuration. Further, in FIG. 8, the same components as those in FIG. 1 or 4 are marked with the same numerals and symbols.

The electronic device 2 in the third embodiment has, in addition to the above-described configuration, e.g., a further configuration including a counter unit such as a timer, whereby when disabled from conducting the login based on the matching process within a predetermined period of set time, the notification of the alarm message of the unauthorized access is executed and the screen is locked.

This electronic device 2 has, together with the above-mentioned configuration, a configuration including an elapse time monitoring unit 40. The elapse time monitoring unit 40 is one example of the monitor function unit which monitors as to whether the set time elapses or not on the basis of time count information acquired from the timer etc. This configuration provides, in addition to the security function related to the matching process, the security function based on the elapse time. That is to say, when the predetermined period of time elapses since the input matching information for matching the password etc. has been requested, the access is considered to be the unauthorized access.

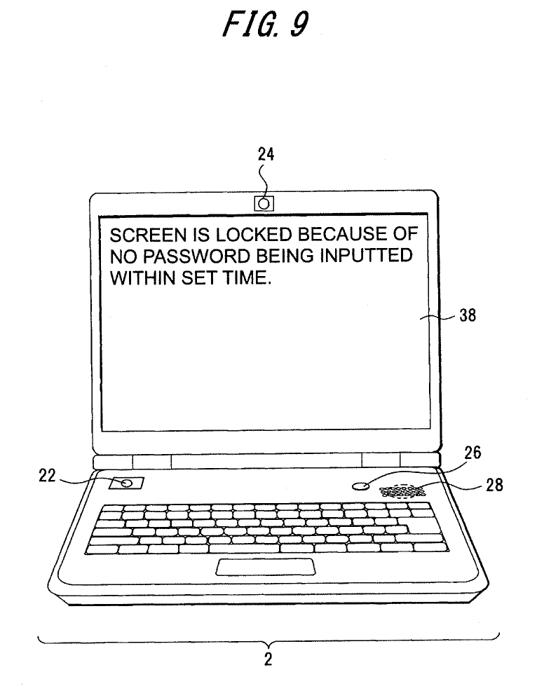

Next, a reference to FIG. 9 will be made for the alarm display based on the elapse time. FIG. 9 is a view depicting a display example of the alarm message due to an excess over the set time. Note that a composition of the display content depicted in FIG. 9 is one example, and the embodiment is not limited to this example.

In this electronic device 2, the access is considered to be the unauthorized access due to the elapse of the predetermined period of time since the input matching information has been requested, e.g., as already stated, the password input screen has been displayed, whereby the screen is locked, and so on. In this case, as depicted in FIG. 9, an alarm message such as “Password is not input within the set time, and the screen is therefore locked.” is displayed on the display screen 38.

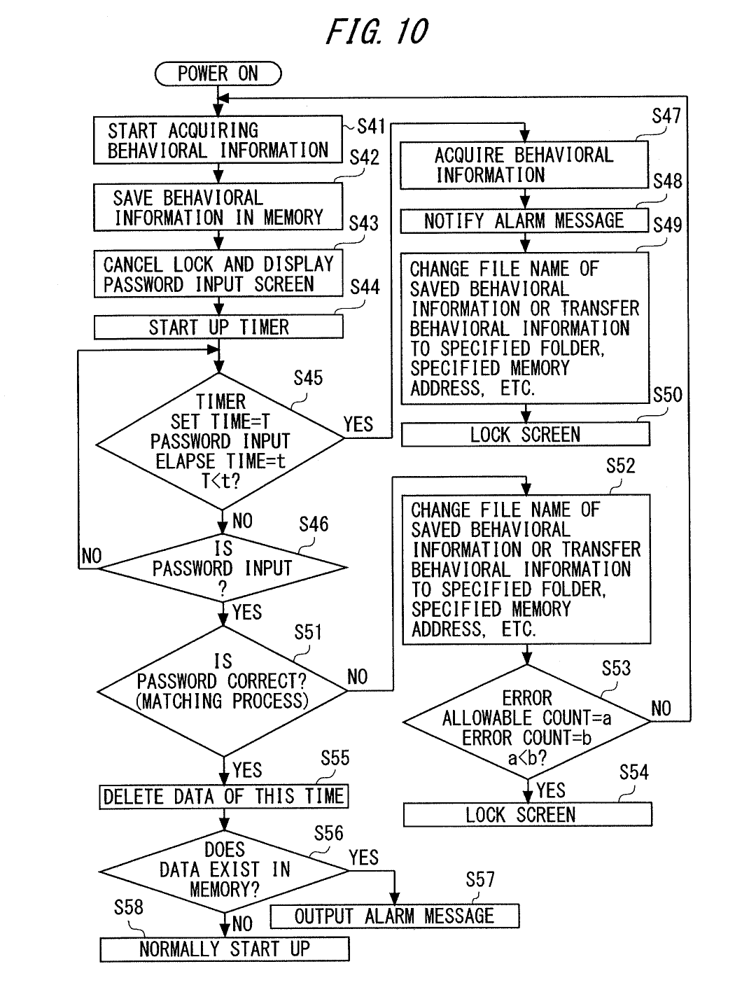

A reference to FIG. 10 will be made for a process of implementing the security function by the electronic device. FIG. 10 is a flowchart illustrating an example of the processing procedure of the electronic device according to the third embodiment. Note that the processing contents, the processing procedure, etc. depicted in FIG. 10 are given by way of one example, and the embodiment is not limited to this example.

As stated above, the acquisition of the behavioral information is started corresponding to the detection of the start-up (step S41), and the behavioral information is temporarily saved in, e.g., the behavioral information recording unit 8 defined as the memory (step S42). Further, for instance, a password input screen is displayed for inputting the data for canceling the lock (step S43).

The start-up of the timer is triggered by displaying the password input screen (step S44). Then, the elapse time monitoring unit 40 monitors the elapse time since the timer has been started up, and determines whether password input elapse time (t) counted, for example, by the timer etc. exceeds timer set time (T) (step S45).

When the password input elapse time t does not reach the timer set time T (T>t) (NO in step S45), it is determined whether the password is input or not (step S46). When the password is not input (NO in step S46), the operation returns to step S45 and comes to an input standby status.

Then, when the elapse time t exceeds the set time T (T<t) without inputting the password (YES in step S45), the behavioral information is again acquired (step S47), and, for example, the notification of the alarm message illustrated in FIG. 9 is executed (step S48). As described above. The file name of the behavioral information recorded in the behavioral information recording unit 8 is changed in a specifiable manner, or alternatively the behavioral information is transferred to the specified folder etc. and recorded therein (step S49), and the screen lock process is carried out (step S50).

Moreover, when the password is input before the elapse time t exceeds the set time T (T>t) (YES in step S46), as the matching process of the input matching information, it is determined whether the password is coincident with the registered matching information (step S51). Then, the processes (step S51-step S58) from this matching process onward may be executed in the same way as the above-mentioned start-up process etc. (step S25-Step S34: FIG. 7) are carried out.

Note that the timer set time T may be set to the overall elapse time till the login is done since the timer has been started up (step S44), and may also be set to a short-term set time till the matching process (step S51) is executed. In this case, in the case of the failure in matching (NO in step S51), after displaying again the password input screen (step S43), the timer may be started up (step S44). Further, the stop of the acquisition of the behavioral information may be, e.g., set after the matching process (step S51) as illustrated in above-mentioned steps S26, S30 (FIG. 7).

According to such a configuration, the same effects as those described above are obtained. Further, a condition of the elapse time is added to the input of the matching information, thereby making it possible to give no extension of time to the unauthorized accessing person and to enhance the security function. Along with this, it is possible to facilitate specifying the unauthorized operator. For example, it is feasible to acquire and record the behavioral information of the status without giving the extension of time for searching for and figuring out the password during the display of the password input screen, thus specifying the operator.

### Fourth Embodiment

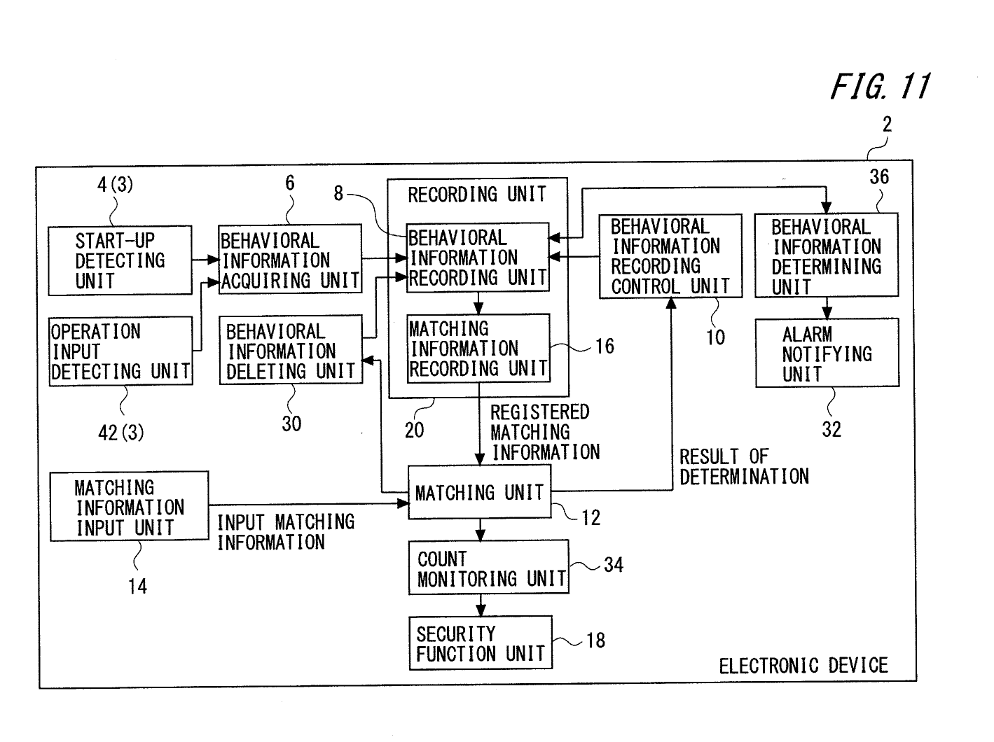

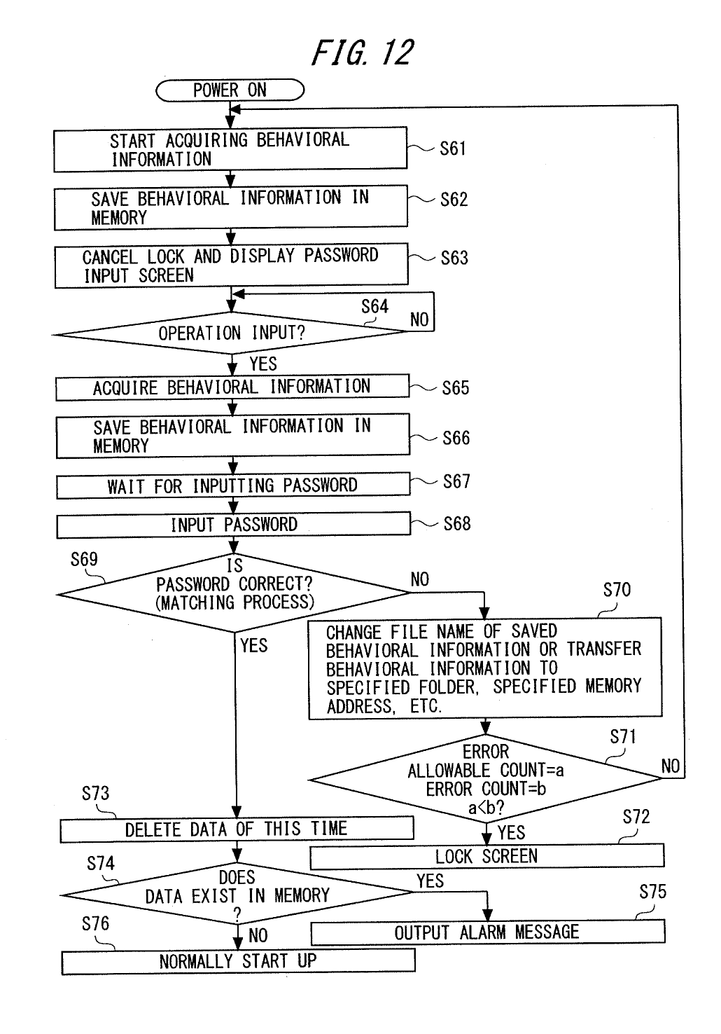

A reference to FIGS. 11 and 12 will be made for a fourth embodiment. FIG. 11 is a diagram illustrating an example of a configuration of the electronic device according to the fourth embodiment, and FIG. 12 is a flowchart depicting an example of the processes, including the operation detection process, of the electronic device. Note that the configuration, the processing contents and the processing procedure depicted in FIGS. 11 and 12 are given by way of one example, and the embodiment is not limited to this example. Further, in FIG. 11, the same components as those in FIG. 4 are marked with the same numerals and symbols.

This electronic device 2 has a configuration including a case in which the acquisition of the behavioral information is triggered at timing when inputting, e.g., the characters on the keyboard and inputting other operations.

The electronic device 2 in the fourth embodiment has a configuration including, as illustrated in FIG. 11, in addition to the configuration in the second embodiment (FIG. 4) discussed above, e.g., an operation input detecting unit 42. The operation input detecting unit 42 is one example of the above-mentioned operation detecting unit 3 and is a unit which detects the depressing and operating statuses of the keyboard etc. defined as the operation input unit of the electronic device 2 and these statuses of other operating unit after being started up. For example, the depressing operation etc. maybe detected by making use of, e.g., a sensor installed at the keyboard etc.

Then, in the same way as checking the start-up by the above-mentioned start-up detecting unit 4, the behavioral information of the operator of the electronic device 2 is recorded by making use of the detection of the operation input.

FIG. 12 depicts an example of the processes, including this operation input detection, of the electronic device. This process is one example of the security method or the security program stored in the electronic device or a recording medium. As described above, the acquisition of the behavioral information is started corresponding to the detection of the start-up (step S61), and the behavioral information is temporarily saved in, e.g., the behavioral information recording unit 8 defined as the memory (step S62). Further, for instance, the password input screen is displayed for inputting the data for canceling the lock (step S63).

Then, the operation input detecting unit 42 detects the input of the operation (step S64). This determination may be made as triggered by detecting the input of, e.g., a first character of the password etc. on the keyboard etc., and may also be made as triggered by detecting the input of a predetermined number of characters. For others, e.g., the detection of the operation input of a mouse etc. equipped in the electronic device 2 may be set as the trigger.

In the case of the operation being input (YES in step S64), the acquisition of the behavioral information is triggered by this input detection (step S65), and the behavioral information is temporarily saved in, e.g., the behavioral information recording unit 8 defined as the memory (step S66). Whereas if the operation is not input (NO in step S64), the standby status continues till the input is done.

Then, the matching information input unit 14 waits for the input-being-started password to be input all (step S67), and, upon being input (step S68), moves to the matching process using the password etc. (step S69). Then, the processes (step S69-step S76) from this matching process onward may be executed in the same way as the above-mentioned start-up process and others (step S25-step S34: FIG. 7) are carried out.

According to such a configuration, the same effects as those described above can be obtained. Further, the behavioral information is acquired as triggered by the operation input of the password etc., thereby enhancing the function of specifying the operator. For example, when inputting the password etc., the operator is positioned in a preset behavioral information acquisition area such as a position enabled to visually recognize the display screen 38 such as the front of the electronic device 2, and thus obtaining the image capture information taken when capturing (the image of) the operator.

### Fifth Embodiment

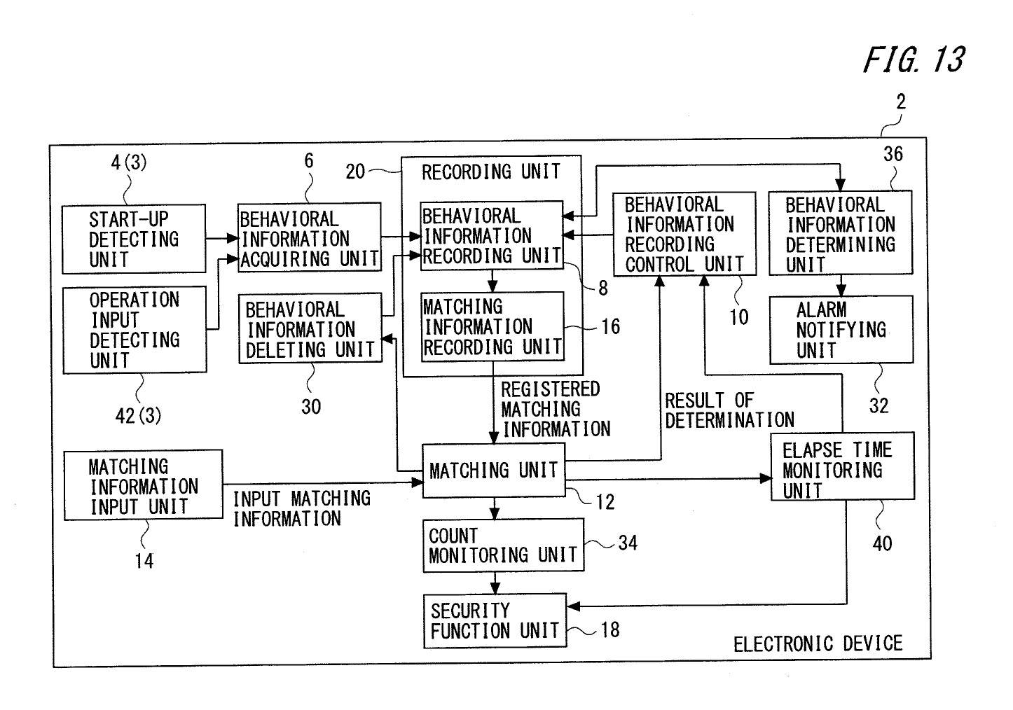

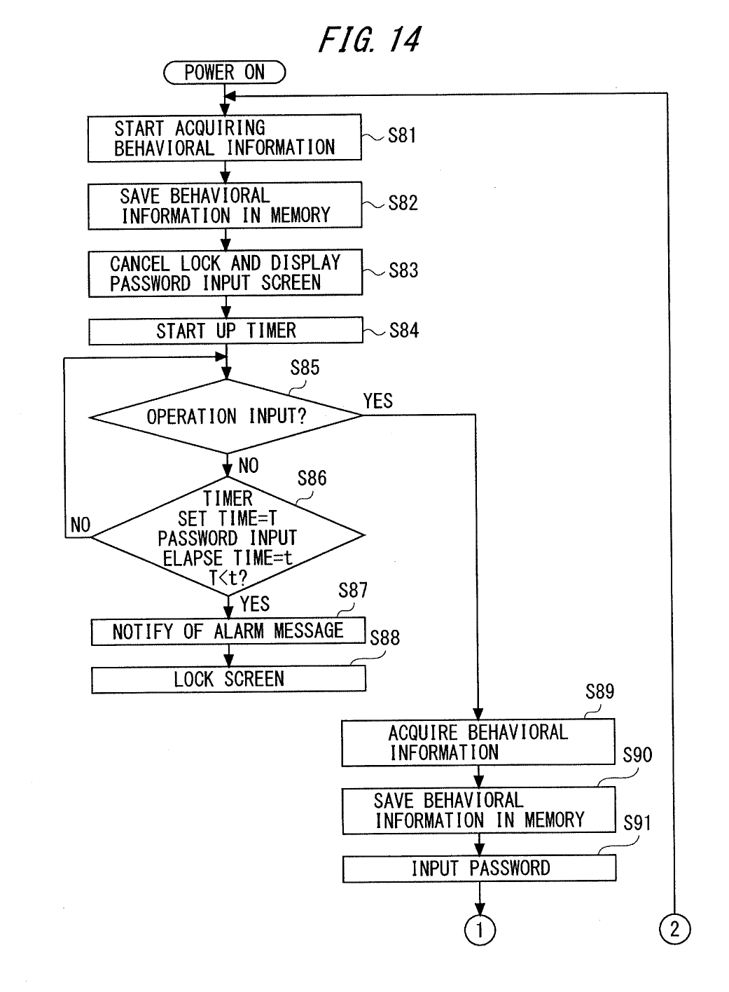

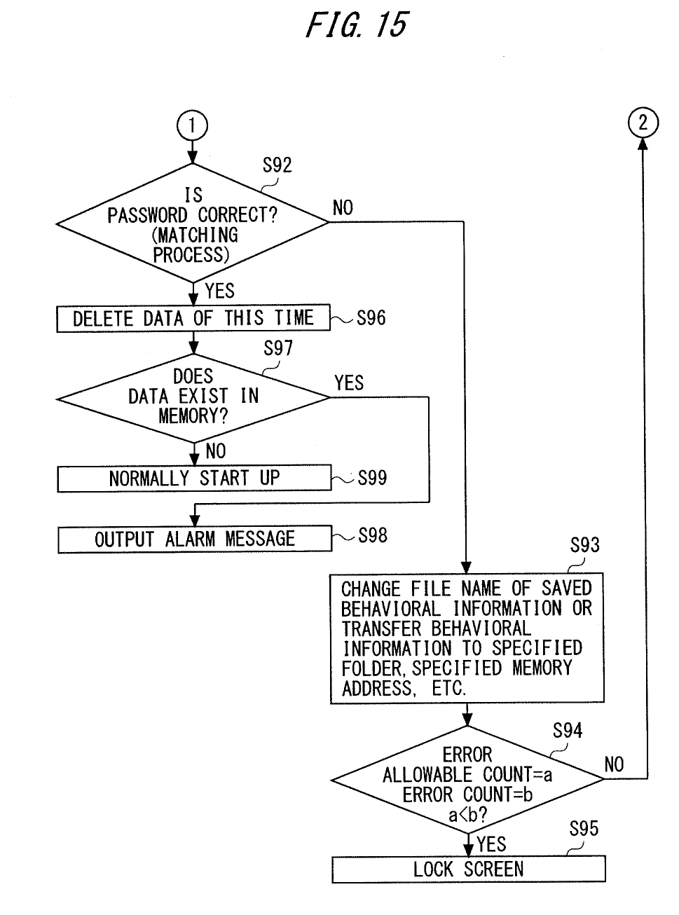

A reference to FIGS. 13, 14 and 15 will be made for a fifth embodiment. FIG. 13 is a diagram illustrating an example of a configuration of the electronic device according to the fifth embodiment, and FIGS, 14, 15 are flowcharts illustrating an example of the processing procedure of the electronic device according to the fifth embodiment. Note that the configuration, the processing contents and the processing procedure depicted in FIGS. 13, 14 and 15 are given by way of one example, and the embodiment is not limited to this example. Further, the numerals 1, 2 illustrated in the processes of FIGS. 14 and 15 represent a connector between these flowcharts.

The electronic device 2 in the fifth embodiment records the behavioral information as triggered by the operation input and, when disabled from conducting the login based on the matching process within a predetermined period of set time, gives the alarm message saying that the access is the unauthorized access, thereby locking the screen.

The electronic device 2 includes, e.g., as illustrated in FIG. 13, the above-mentioned elapse time monitoring unit 40 and the operation input detecting unit 42.

FIG. 14 depicts an example of the processing procedure etc. of the electronic device 2 in the configuration such as this. This processing procedure is one example of the security method or the security program of the electronic device 2.

To begin with, as illustrated in FIG. 14, as already described, the behavioral information is acquired corresponding to the detection of the start-up (step S81), and the behavioral information is saved in, e.g., the behavioral information recording unit 8 defined as the memory (step S82). Further, for instance, the password input screen is displayed for inputting the data for canceling the lock (step S83). The start-up of the timer is triggered by displaying this input screen (step S84).

Moreover, the operation input detecting unit 42 detects the input of the operation on the electronic device 2 (step S85). In this detection of the operation input, the input of the first character of the password on, e.g., the keyboard etc. is monitored. That is to say, this process involves monitoring the elapse time till the password is input and monitoring the operation input in parallel.

When not conducting the operation input (NO in step S85) and the password input elapse time t does not reach the timer set time T (T>t) (NO in step S86), the standby status occurs. Further, whereas when the password input elapse time t reaches the timer set time T (T<t) in this status (YES in step S86), the access is considered to be the unauthorized access, and the alarm message is displayed on, e.g., the display screen 38 etc. (step S87), thereby locking the screen (step S88).

Note that when the elapse time t reaches the timer set time T (T<t), as illustrated in step S47 and step S49 (FIG. 10), the behavioral information is acquired, and the specifying process thereof may be executed.

Moreover, when the operation input is conducted (YES in step S85), the behavioral information is acquired (step S89), and the behavioral information is saved in, e.g., the behavioral information recording unit 8 defined as the memory (step S90). Then, when the password defined as the matching information is input all (step S91), the operation moves to the matching process (step S92).

It is to be noted that the count monitor process after the matching process and the data deleting process when logging in (step S92-step S99) may be executed in the same way as the above-mentioned steps S25-S34 (FIG. 7) are conducted.

According to such a configuration, the same effects as those described above can be obtained.

### Sixth Embodiment

A sixth embodiment includes a process of transmitting the acquired behavioral information and present position information etc. of the electronic device to other communication-enabled electronic devices.

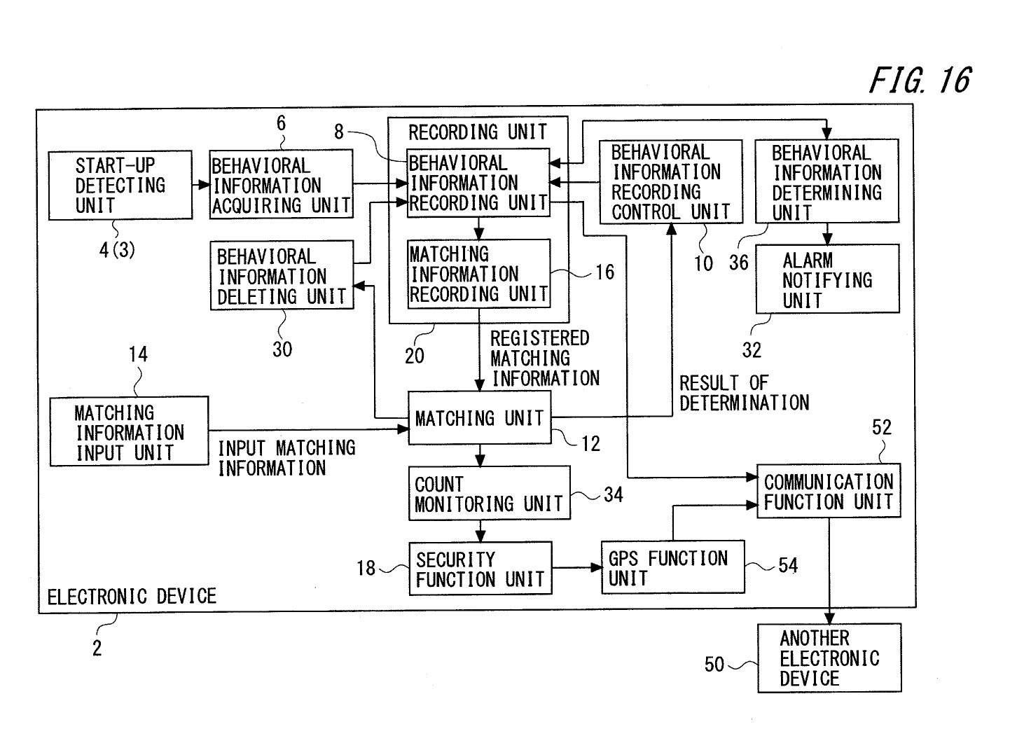

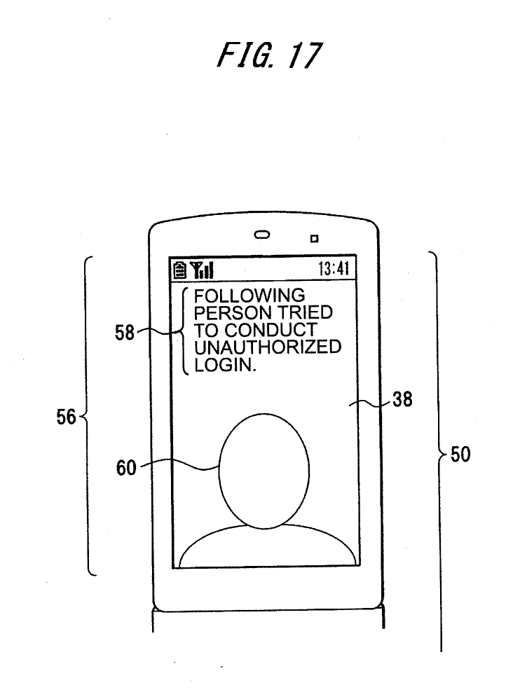

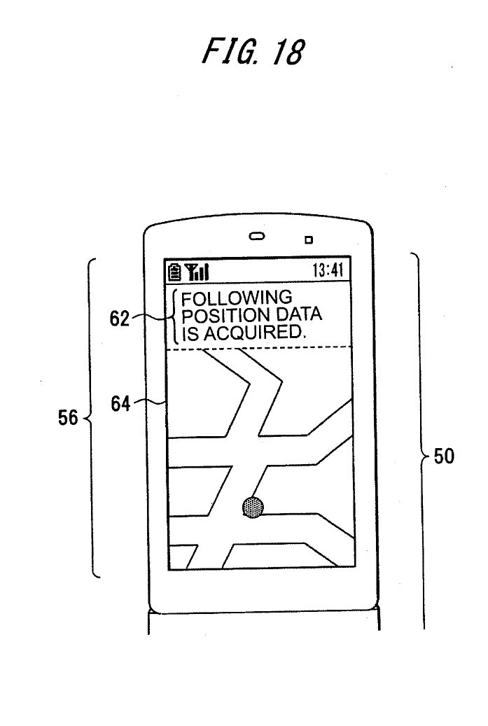

A reference to FIGS. 16, 17 and 18 will be made for the sixth embodiment. FIG. 16 is a diagram illustrating an example of a configuration of the electronic device according to the sixth embodiment, FIG. 17 is a view depicting a display example of the behavioral information received by another electronic device, and FIG. 18 is a view depicting a display example of the present position information of the electronic device, which is received another electronic device. Note that the configuration, the display mode, etc. depicted in FIGS. 16, 17 and 18 are given by way of one example, and the embodiment is not limited to this example. In FIG. 16, the same components as those in FIG. 4 are marked with the same numerals and symbols.

The electronic device 2 in the sixth embodiment includes, in addition to the above-mentioned configuration, a function of transmitting the acquired behavioral information to another electronic device 50 of a person holding the authority for operating, e.g., the electronic device 2. Moreover, the configuration is that for instance the electronic device 2 is taken out, in which case the present position information of the electronic device 2 is transmitted to another electronic device 50. Such being the case, the electronic device 2 includes, in addition to the above-mentioned configuration, e.g., a communication function unit 52, a GPS (Global Positioning System) function unit 54, etc.

The communication function unit 52 is one example of a transmitting unit which establishes and maintains communications for transmitting the data etc. to another electronic device 50 existing outside. The transmission and the reception of the data may involve utilizing a network such as the Internet. Further, as a communication mode, wired or wireless communications and IR (Infrared Ray) communications may be utilized.

The GPS function unit 54 is one example of a position information acquiring unit which acquires the present position information of the electronic device 2 through the communications with a GPS satellite etc.

Then, another electronic device 50 receiving the behavioral information from this electronic device 2 displays, e.g., as depicted in FIG. 17, an alarm message 58 indicating that the unauthorized access to the electronic device 2 is conducted and an image 60 defined as the image capture information of the behavior on a display unit 56. Furthermore, for example, the voice information defined as the behavioral information may be output from a receiver, speaker, etc.

Further, the present position information of the electronic device 2 is such that as illustrated in FIG. 18, a message 62 saying that “the following position data is obtained” is displayed on the display unit 56, and also map information 64 is displayed thereon.

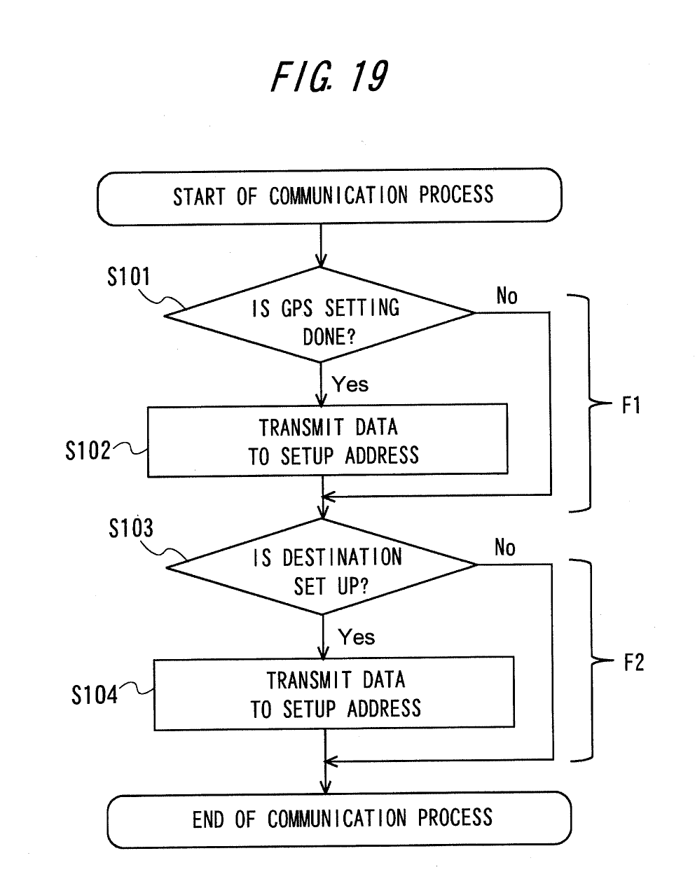

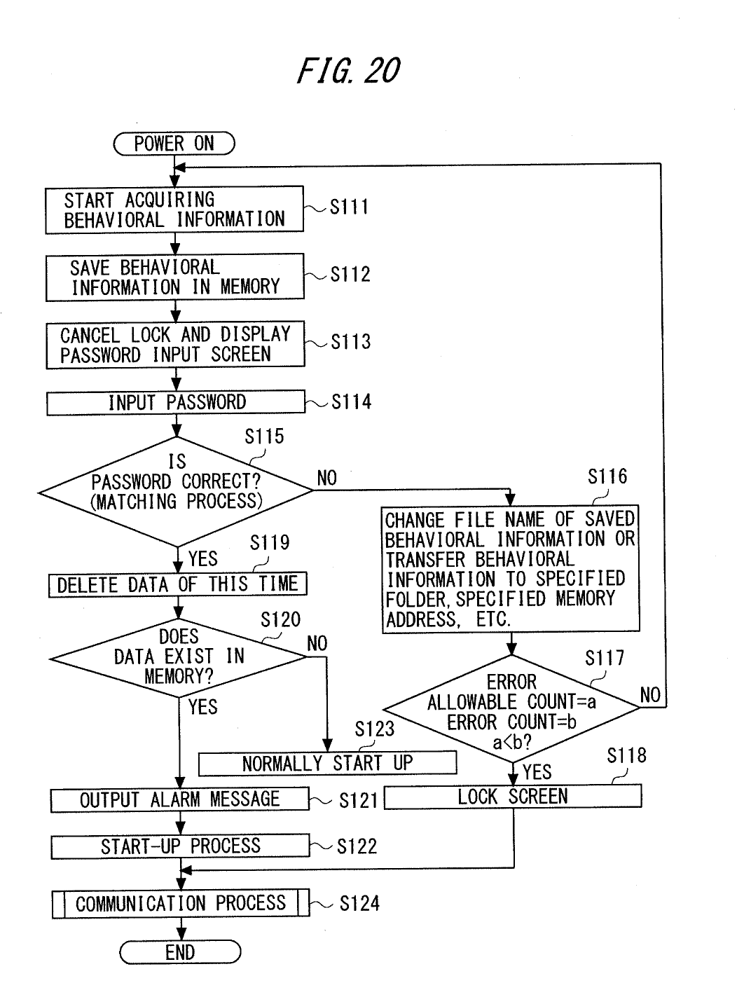

Next, a reference to FIGS. 19 and 20 will be made for a data communication process from the electronic device to another electronic device. FIG. 19 is a flowchart illustrating an example of the communication process of the electronic device, and FIG. 20 is a flowchart illustrating an example of the processing procedure of the electronic device according to the sixth embodiment. Note that the processing content, the processing procedure, etc. depicted in FIGS. 19 and 20 are given by way of one example, but the embodiment is not limited to this example.

This communication process contains, e.g., a position information transmitting process (F1) by the GPS function unit 54 and a transmitting process (F2) of the behavioral information etc. to another electronic device 50.

Upon starting the communication process, as illustrated in FIG. 19, as the position information transmitting process (F1), it is determined whether the GPS function is set in the electronic device 2 (step S101). If set therein (YES in step S101), the position information is acquired, and, e.g., the present position information is transmitted to a set address of another electronic device 50 etc. (step S102).

Note that this position information may also be, e.g., as illustrated in FIG. 18, transmitted together with the peripheral map information 64. This map information 64 may be stored by, e.g., the electronic device 2 or another electronic device 50 which receives this information, or may be downloaded from a Web site etc. as the necessity may arise. Further, the position information may be, for instance, coordinate position information.

Next, as the transmitting process (F2), it is determined whether a data transmitting destination (destination address) of the behavioral information etc. is set or not (step S103). If set, the behavioral information recorded in the behavioral information recording unit 8 etc. is transmitted to the set address (step S104). The processes described above are done, and then the communication process is terminated.

In this communication process, the process F1 and the process F2 may be, e.g., executed simultaneously without being limited to the case of being performed in this processing sequence. Further, such setting may be done that only any one of the position information transmitting process (F1) and the data transmitting process (F2) is executed. Moreover, as for the timing when the GPS function unit 54 acquires the position information, the position information may be periodically acquired corresponding to, e.g., the shift to the communication process and may also be acquired in accordance with the data transmitting process to the set address (step S102).

Next, a reference to FIG. 20 will be made for the start-up process, including the communication process, of the electronic device 2. In this process, the security function against the unauthorized access to the electronic device 2 is that when the error count as the matching failure count exceeds the allowable count (YES in step S117) and when the screen is locked (step S118), the communication process is carried out (step S124). Further, even when succeeding in matching and logging in, if the behavioral information indicating the unauthorized access is recorded in the behavioral information recording unit 8 defined as the memory (YES in step S120), the communication process is performed (step S124). In the communication process when successfully matched, for instance, after outputting the alarm message (step S121), the electronic device 2 is started up to an operation-enabled status (step S122), and the behavioral information is transmitted (step S124). Through this process, for example, even when the unauthorized accessing person succeeds in matching, as far as the behavioral information is recorded, this behavioral information is transmitted, and hence it is feasible to specify the unauthorized accessing person who operates the electronic device 2.

Note that the recording process of the behavioral information, the security function process, etc. (step S111-step S121, step S123) exemplified in FIG. 20 may be conducted in the same way as the above-mentioned step S21-step S34 (FIG. 7) are executed.

Thus, the communication process with respect to the position information and the behavioral information (step S111-S124) is exemplified corresponding to the start-up process of the electronic device 2 depicted in FIG. 7, however, the embodiment is not limited to this example. For example, this communication process may also be similarly executed in the third embodiment (FIG. 10) including the above-mentioned elapse time monitoring process, the fourth embodiment (FIG. 12) including the operation input monitoring process and the fifth embodiment (FIG. 14) including the combination of these processes. At this time, the communication process may be executed, as the security function against the unauthorized access, in the case of recording the behavioral information attached with the identifying information etc. in the recording unit, in the case of locking the screen and in the case of outputting the alarm message. Owing to this process, for instance, in any one of the case where the behavioral information of the last time is recorded, the case where the login is unable to be done within the set period of time (timer setting) and the case where the matching gets into the failure due to the excess over the set allowable count, the behavioral information can be transmitted to another electronic device 50.

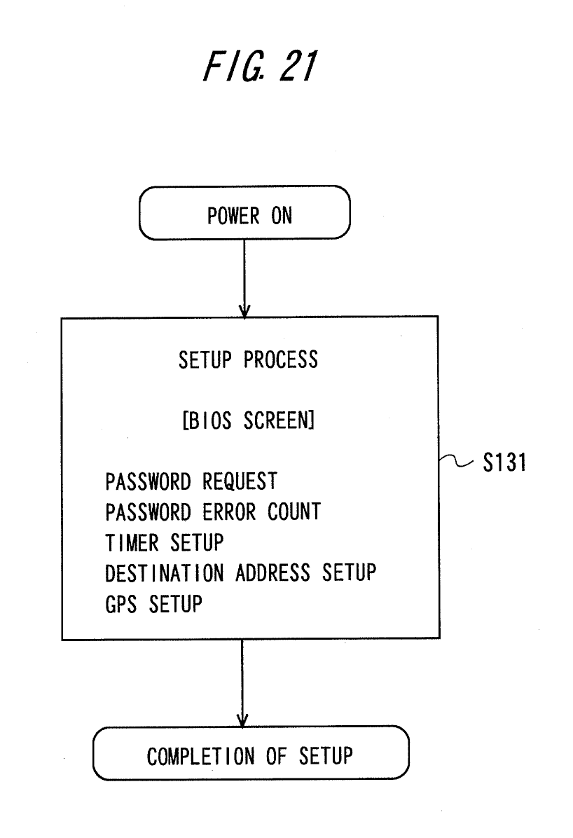

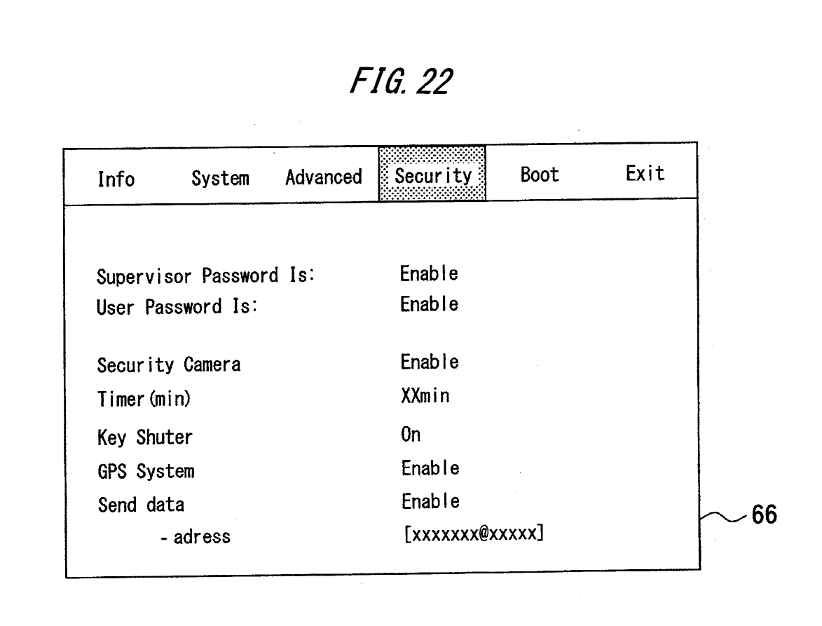

Next, a reference to FIGS. 21 and 22 will be made for pre-setting of the communication function etc. with respect to the electronic device 2. FIG. 21 is a flowchart illustrating an example of a pre-setting process of the electronic device, and FIG. 22 is a diagram illustrating an example of a setup screen of the electronic device. Note that a setting procedure and display contents illustrated in FIGS. 21 and 22 are given by way of one example.

The processing functions of the electronic device 2 are, e.g., as depicted in FIG. 21, set in BIOS (Basic Input/Output System) which controls the respective function units of the electronic device 2. This setting process (step S131) involves setting the security function and the transmission processing function of the electronic device 2.

As illustrated in FIG. 22, for instance, on a BIOS setup screen 66, the password and the password error count are set by way of one example of the matching processing function, the security camera 22, which is one example of the behavioral information acquiring unit, is set and the timer for monitoring the elapse time is set, etc. The setting of the communication processing function involves performing the setting in the GPS function unit 54, the setting in the communication function unit 52 which transmits the data and the setting of the destination address.

According to such a configuration, the same effects as those described above can be obtained. Further, even when the electronic device 2 itself is taken out, it is possible to acquire the behavioral information of this taker and to grasp the position of the electronic device 2.

### Seventh Embodiment

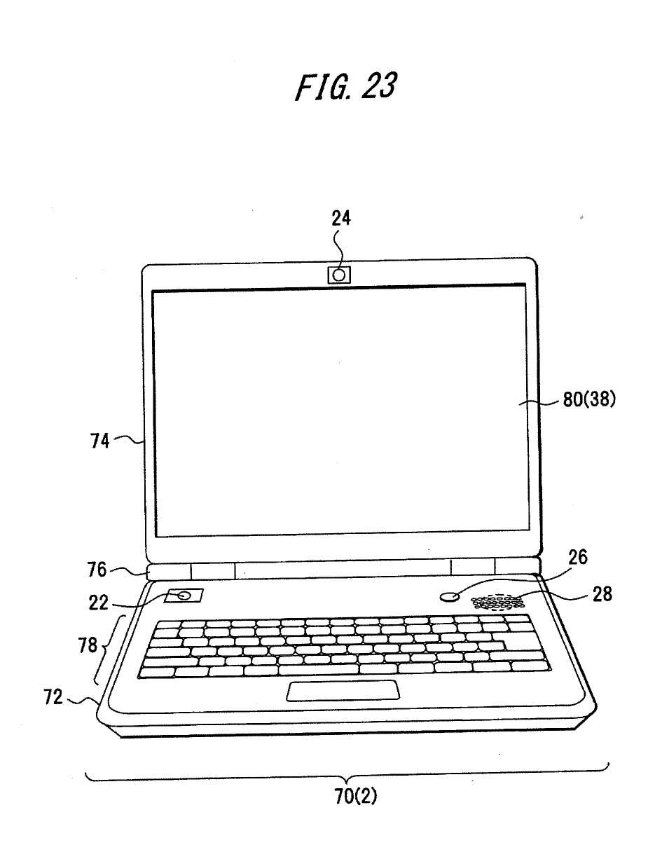

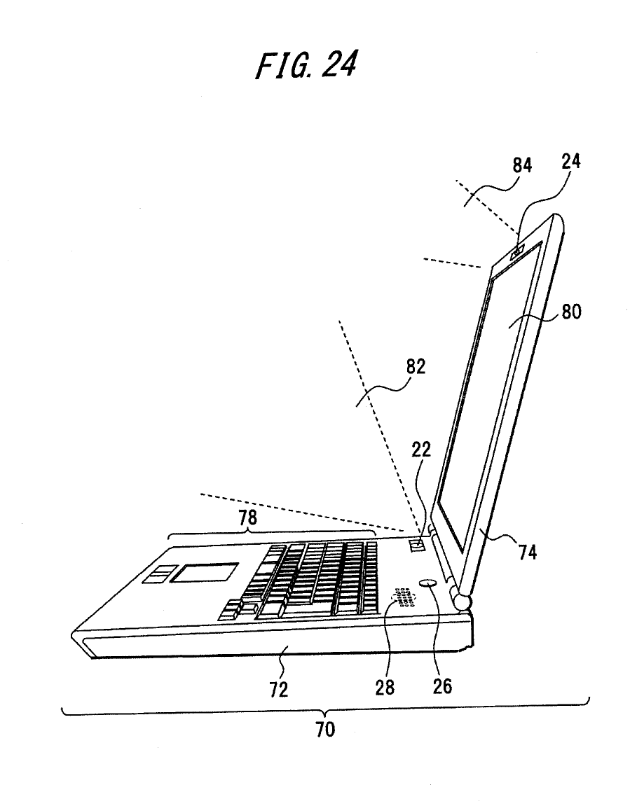

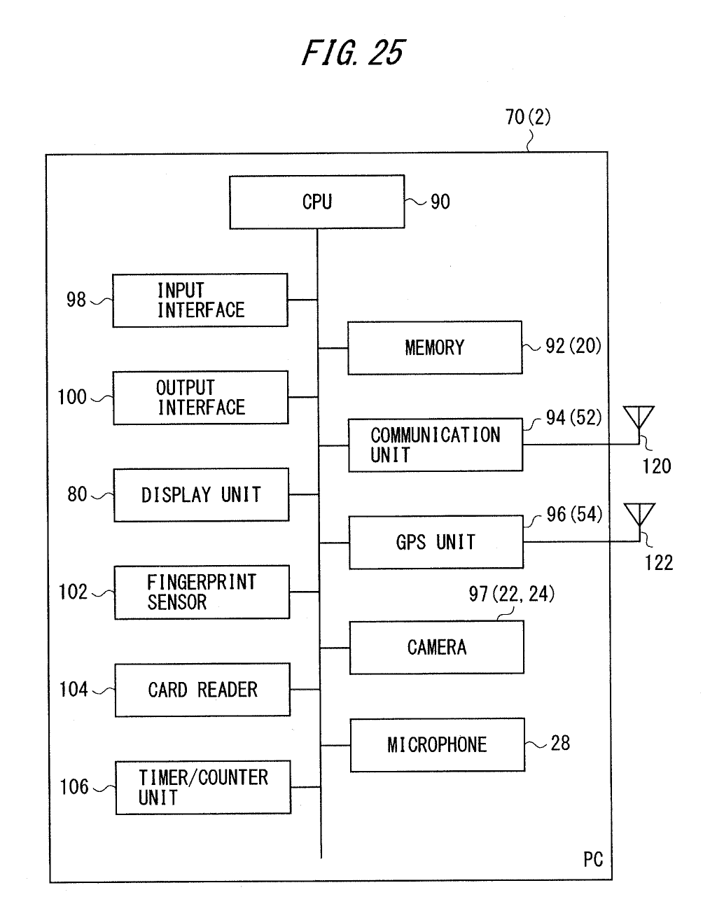

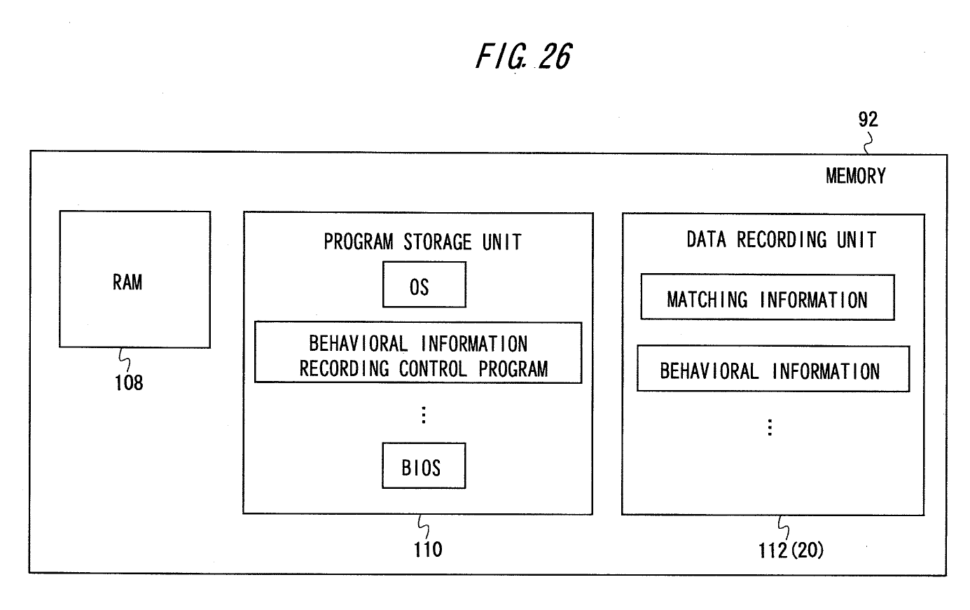

A reference to FIGS. 23, 24, 25 and 26 will be made for the configuration of the electronic device. FIG. 23 is a view illustrating an example of an external configuration of a PC, FIG. 24 is a view depicting an example of a behavioral information acquisition area, FIG. 25 is a diagram illustrating an example of a hardware architecture of the PC, and FIG. 26 is a diagram illustrating an example of a configuration of the memory. Note that the configurations illustrated in FIGS. 23, 24, 25 and 26 are given by way of one example, and the embodiment is not limited to this example.

A PC 70 is, as depicted in FIG. 23, one example of the electronic device 2. This PC 70 is equipped with a foldable housing, and this housing has a configuration including a fixing side housing unit 72 as a first housing unit, a movable side housing unit 74 as a second housing unit and a hinge unit 76 via which these housing units 72, 74 are connected and thus get openable and closable.

The fixing side housing unit 72 is provided with an operation input unit 78, the start-up switch 26, the security camera 22, the microphone 28, etc. The operation input unit 78 is one example of an input interface with the PC 70 and has a configuration including, e.g., the keyboard, the mouse and other input buttons. The start-up switch 26 is a start-up unit of the PC 70. The security camera 22 is one example of the behavioral information acquiring unit and includes, e.g., a wide-angle camera, etc.

The microphone 28 is one example of the behavioral information acquiring unit which collects sounds (voices). For example, a sound-collectable area of the microphone 28 is set as the behavioral information acquisition area described above.

Further, the movable side housing unit 74 is provided with the inbuilt camera 24 and a display unit 80. The inbuilt camera 24 is one example of the behavioral information acquiring unit or the image capturing unit provided in the PC 70, and is a camera as a normal type of digital camera capable of arbitrarily capturing the image by the user of the electronic device 2. It is to be noted that the inbuilt camera 24 may take, e.g., a configuration enabled to change arbitrarily the image capturing direction. Then, in the behavioral information acquiring process based on the security function of the PC 70, this inbuilt camera 24 may be employed as a substitute for or together with the above-mentioned security camera 22.

Incidentally, this inbuilt camera 24 has the arbitrary configuration and may, if configured to acquire the behavioral information through the above-mentioned security camera 22, take a configuration of not being installed in the PC 70.

In regard to the acquisition of the behavioral information by the PC 70, FIG. 24 illustrates a status of acquiring the behavioral information by, for instance, the security camera 22 or the inbuilt camera 24. In this case, the security camera 22 or the inbuilt camera 24 acquires the image capture information of the images of, e.g., the face, the clothing, etc. as the behavioral information of the operator of the PC 70. Such being the case, the behavior area of the operator who touches the start-up switch 26 is set as an image capture range, and this image capture range embraces the behavioral information acquisition areas 82, 84. That is, for example, the image capture range of the cameras 22, 24 and the sound collecting range of the microphone 28 etc. are so set as to be adjusted to the behavior area of the operator who touches the start-up switch 26.

The hardware architecture of the PC 70 is a configuration including, as illustrated in FIG. 25, e.g., a CPU (Central Processing Unit) 90, a memory 92, a communication unit 94, a GPS unit 96, a camera 97 (22, 24), a microphone 28, an input interface 98, an output interface 100, a display unit 80, a fingerprint sensor 102, a card reader 104, a timer/counter unit 106, etc.

The CPU 90 is one example of an arithmetic unit for executing OS (Operating System), a variety of programs, etc. stored in the memory 92, and executes processes such as carrying out the matching process in the above-mentioned matching unit 12, attaching the identifying information to the behavioral information and deleting the data.

The memory 92, which is one example of a storage unit or a recording unit, is recorded with, e.g., the OS for controlling the operation etc. of the PC 70, other control programs etc. and the acquired behavioral information etc., and builds up the above-mentioned recording unit 20 etc. The memory 92 includes, e.g., as illustrated in FIG. 26, a RAM (Random Access Memory) 108, a program storage unit 110 and a data recording unit 112.

The RAM 108 configures a work area for executing the variety of programs, in which the programs are executed, thereby constructing the control unit such as the above-mentioned behavioral information recording control unit 10, the behavioral information determining unit 36, the behavioral information deleting unit 30 and the elapse time monitoring unit 40. Then, instructions are given to the respective function units of the PC 70 on the basis of the predetermined processing timing. Further, such instructive control is performed that the cameras 22, 24 are started up by, e.g., the BIOS (Basic Input/Output System) etc. in accordance with the detection of the start-up of the PC 70 to execute the acquisition of the behavioral information, and this behavioral information is saved in the data recording unit 112 building up the recording unit 20.

The program storage unit 110 has a configuration including, e.g., a ROM (Read Only Memory) and is one example of a unit stored with the programs for executing the operation control of the PC 70 and the acquisition of the behavioral information etc. This program storage unit 110 is stored with the OS, the BIOS for controlling the peripheral devices of another electronic device 50, a behavioral information recording control program, a behavioral information determination program, and so on.

The data recording unit 112, which is one example of a unit which records the acquired behavioral information and the matching information used for the matching process, builds up the above-mentioned recording unit 20 and has a configuration including, e.g., the ROM and a flash memory.

Note that the program storage unit 110 and the data recording unit 112 may be each configured to include, e.g., an EEPROM (Electrically Erasable and Programmable Read Only Memory) etc. capable of electrically rewriting the contents.

Moreover, the processing programs described above are not limited to those stored in the program storage unit 110, and, for instance, programs stored on a non-transitory computer-readable medium such as a magnetic disc, a flexible disc, an optical disc and a magneto-optical disc may also be utilized. Further, programs existing on the network may also be read and utilized.

Furthermore, the communication unit 94 depicted in FIG. 25 is one example of the communication function unit 52 and performs, e.g., the wired or wireless data communications. In the case of the wireless communications, the communication unit 94 includes a communication antenna 120 through which to perform the communications with another electronic device 50 via the network such as a LAN (Local Area Network) and the Internet etc. For others, e.g., the IR communications, Bluetooth (registered trademark), etc. may also be utilized.

The GPS unit 96, which is one example of a position information acquiring unit, includes, e.g., a GPS antenna 122 and configures the above-mentioned GPS function unit 54.

The camera 97 is one example of the behavioral information acquiring unit and is configured by, e.g., the above-mentioned security camera 22 and the inbuilt camera 24.

The microphone 28 is one example of the behavioral information acquiring unit and is a unit which collects the voice information such as the voices of the operator of the PC 70 and the ambient sounds. The behavioral information of the sounds collected by the microphone 28 is vocally recorded in the recorder etc. of the PC 70 and is recorded in the data recording unit 112 etc.

The input interface 98 is one example of the input unit to the PC 70 and configures, e.g., the operation detecting unit 3, the start-up detecting unit 4, the operation input detecting unit 42, etc. The operation input unit 78 such as the start-up switch 26′ and the keyboard etc. is connected to the input interface 98.

The output interface 100 is one example of the output unit of the PC 70, and, for instance, an external recording medium, the speaker, etc. are connected thereto. For example, the alarm notification using the voices maybe given.

The display unit 80, which is one example of the display unit of the PC 70, has a configuration including, e.g., an LCD (Liquid Crystal Display) display device and displays, e.g., the matching process of the operator, the acquired behavioral information, etc.

The fingerprint sensor 102 is one example of the matching information input unit 14 and is configured to input the finger information, the vein information, etc. in the case of performing the biometric verification as the matching process.

The card reader 104 is one example of the matching information input unit 14 and is the input unit in the case of using, e.g., the smartcard etc. recorded with the ID information of the operator as the matching process.

The timer/counter unit 106 is one example of a timer unit/counter unit and configures the above-mentioned count monitoring unit 34, the elapse time monitoring unit 40, etc.

According to such a configuration, it is feasible to implement the security function of the electronic device illustrated in the embodiment discussed above and obtain the above-mentioned effects.

### Other Embodiments

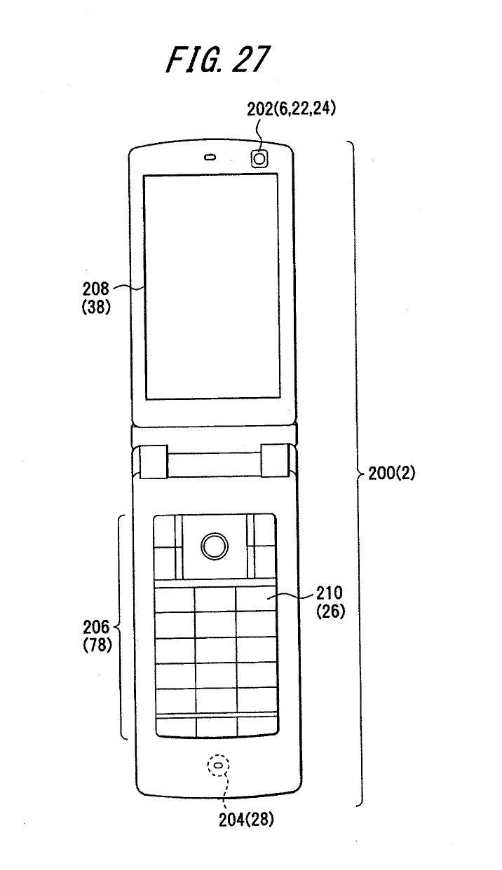

(1) The seventh embodiment has exemplified the PC 70 by way of the electronic device, the security method, the security program and the recording medium, however, without being limited to this PC, for instance, as depicted in FIG. 27, a mobile phone 200 may also be utilized. In this case, it may be sufficient to include a camera 202 and a microphone 204 as the behavioral information acquiring unit 6, an operation input unit 206, a display unit 208, a start-up switch 210, etc.

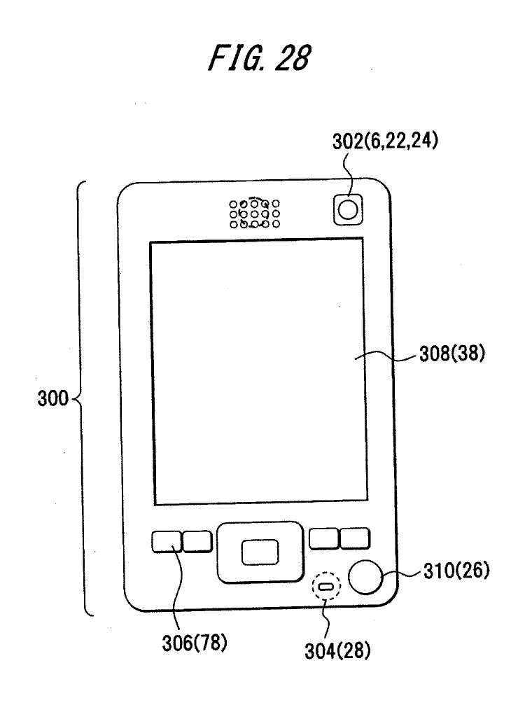

(2) Further, as depicted in FIG. 28, a PDA (Personal Digital Assistant) 300 may also be used, and similarly it may be sufficient to include a camera 302 and a microphone 304 as the behavioral information acquiring unit 6, an operation input unit 306, a display unit 308, a start-up switch 310, etc.

(3) In the embodiments described above, the camera defined as the behavioral information acquiring unit is not limited to the security camera 22 and the inbuilt camera 24 that are built in the electronic device 2 such as the PC 70 etc. For example, an external camera such as a Web camera etc. having a wired or wireless connection with the electronic device is also available. In this case, as a configuration of the electronic device 2, the data of the behavioral information may be transferred and received via, e.g., the communication function unit 52, the input interface 98, etc. which transfer and receive the data to and from the external device etc. According to such a configuration, it is feasible to set arbitrarily the behavioral information acquisition area in which to acquire the behavioral information of the operator, increase further the acquisition efficiency of the behavioral information and improve the security function.

(4) In the embodiments described above, the detection of depressing the start-up switch 26 by the start-up detecting unit 4 is utilized as the behavioral information acquisition timing when starting up the electronic device 2, however, the embodiment is not limited to this timing. For example, the unauthorized accessing person is requested for the password in the matching process, in which case the re-depression of the start-up switch 26 in order to switch off the power source of the electronic device 2 may also be detected. Then, the behavioral information may be acquired at this power-off timing.

(5) In the embodiments described above, the acquired image capture information etc. is utilized as the behavioral information for determining whether or not there is the unauthorized access in accordance with the matching result of the operator, however, without being limited to this utilization, for instance, the acquired image capture information etc. may also be utilized for the identity verification. For example, the image processing etc. is applied to the face image of the operator, whereby the contour information of the face may be captured and set as the input matching information.

As discussed above, there have been made the descriptions of the exemplary embodiments of the electronic device, the security method thereof, the security program thereof or the recording medium, however, the present invention is not limited to the descriptions given above, it is a matter of course that a variety of modifications and changes can be attained by those skilled in the art on the basis of the gist of the invention that is described in the scope of claims or disclosed in the specification, and it is needless to say that these modifications and changes are embraced by the scope of the present invention.

According to the electronic device, the security method thereof, the security program thereof and the recording medium of the embodiments described above, the following effects are obtained.

(1) The behavioral information of the operator is acquired as triggered by the operation of the operating unit, thereby improving the accuracy of acquiring the unauthorized access information and enhancing the function of monitoring the unauthorized access to the electronic device. Namely, a start of acquiring the behavioral information is triggered by the first operation, irrespective of a matching result etc., thereby making it possible to prevent the behavioral information of the unauthorized accessing person from being missed.

(2) The behavioral information acquired from the operator is recorded as triggered by the operation of the operating unit, thereby enhancing the function of monitoring the unauthorized access to the electronic device, the recording function and the function of specifying the unauthorized accessing person. That is to say, the record of the behavioral information contributes to facilitate a check of the unauthorized access and specification of the unauthorized accessing person, and the behavioral information which is acquired as triggered by the operation of the operating unit is used, thereby enhancing the accuracy of checking the unauthorized access and the accuracy of specifying the unauthorized accessing person.

(3) The behavioral information acquired from the operator is recorded as triggered by the operation of the operating unit when the input matching information is not coincident with the registered matching information, and hence it is feasible to enhance efficiency of the function of monitoring the unauthorized access to the electronic device, the recording function and the function of specifying the unauthorized accessing person.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An electronic device comprising:
an operating unit;
a behavioral information acquiring unit to acquire behavioral information of an operator as triggered by operation of the operating unit;
a matching unit to match input matching information input by the operator against registered matching information;
a recording unit to be recorded with the behavioral information; and
a recording control unit to record, when the matching unit determines that the input matching information is not coincident with the registered matching information, the behavioral information in the recording unit.

2. The electronic device according to claim 1, wherein the recording control unit, when recording the behavioral information in the recording unit, records the behavioral information attached with identifying information containing date/time information in the recording unit.

3. The electronic device according to claim 1, further comprising:
a notifying unit to notify, when the behavioral information is recorded in the recording unit, that the behavioral information is recorded on the occasion of starting up the electronic device.

4. The electronic device according to claim 1, wherein the behavioral information acquiring unit continuously acquires the behavioral information or discontinuously acquires the behavioral information.

5. The electronic device according to claim 1, wherein the behavioral information contains any one item, any two or more items or all items of information among image capture information, sound record information and biometric information.

6. The electronic device according to claim 1, wherein the behavioral information acquiring unit acquires the behavioral information as triggered by input the input matching information.

7. The electronic device according to claim 1, wherein the behavioral information acquiring unit acquires, when the input matching information does not become coincident with the registered matching information within a predetermined period of time or when not coincident till a matching count is equal to or smaller than a predetermined count, the behavioral information of the operator.

8. The electronic device according to claim 1, wherein the recording control unit records, when the input matching information does not become coincident with the registered matching information within a predetermined period of time or when not coincident till a matching count is equal to or smaller than a predetermined count, the acquired behavioral information in the recording unit.

9. The electronic device according to claim 1, further comprising:
a function inhibiting unit to, when the behavioral information is recorded in the recording unit, inhibit a part or the whole of functions of the electronic device.

10. The electronic device according to claim 1, further comprising:
a transmitting unit to transmit the behavioral information existing in the recording unit as triggered by recording the behavioral information in the recording unit.

11. The electronic device according to claim 10, further comprising:
a position information acquiring unit to acquire position information,
wherein the transmitting unit transmits the behavioral information existing in the recording unit together with the position information acquired by the position information acquiring unit as triggered by recording the behavioral information in the recording unit.

12. A security method of an electronic device including an operating unit, comprising;
acquiring behavioral information of an operator as triggered by operation of the operating unit;
matching input matching information input by the operator against registered matching information; and
recording the behavioral information in a recording unit when determining that the input matching information is not coincident with the registered matching information.

13. The security method of the electronic device according to claim 12, wherein the recording the behavioral information in the recording unit includes recording the behavioral information attached with identifying information containing date/time information.

14. The security method of the electronic device according to claim 12, further comprising:
notifying, when the behavioral information is recorded in the recording unit, that the behavioral information is recorded on the occasion of starting up the electronic device.

15. A non-transitory computer readable recording medium storing a security program executed by a computer of an electronic device including an operating unit, the security program comprising computer-executable instructions to perform:
acquiring behavioral information of an operator as triggered by operation the operating unit;
matching input matching information input by the operator against registered matching information; and
recording the behavioral information in a recording unit when determining that the input matching information is not coincident with the registered matching information.

16. The non-transitory computer readable recording medium according to claim 15, wherein the recording the behavioral information in the recording unit includes recording the behavioral information attached with identifying information containing date/time information.

17. The non-transitory computer readable recording medium according to claim 15, the security program comprising computer-executable instructions to further perform:
making a notifying unit notify, when the behavioral information is recorded in the recording unit, that the behavioral information is recorded on the occasion of starting up the electronic device.
